(19) United States
(12) Patent Application Publication
(10) Pub. No.: US 2026/0322541 A1
(43) Pub. Date: Oct. 15, 2026

(54) NUMEROLOGY, FRAME STRUCTURE, AND SIGNAL RESOURCE DIMENSIONING FOR JOINT COMMUNICATION AND SENSING SYSTEMS

(71) Applicant: Intel Corporation, Santa Clara, CA (US)

(72) Inventors: Fatemeh Hamidi-Sepehr, San Jose, CA (US); Thushara Hewavithana, Tempe, AZ (US); Debdeep Chatterjee, San Jose, CA (US); Mark Lehne, Hillsboro, OR (US); Qian Li, Beaverton, OR (US)

(21) Appl. No.: 19/102,771

(22) PCT Filed: Sep. 6, 2023
(86) PCT No.: PCT/US2023/032025

§ 371 Date: Feb. 10, 2025

Related U.S. Application Data
(60) Provisional application No. 63/407,415, filed on Sep. 16, 2022.
(60) Provisional application No. 63/414,753, filed on Oct. 10, 2022.

(51) Int. Cl. H04L 5/00; H04L 27/26; H04W 64/00

(52) U.S. Cl. CPC H04L 5/0007; H04L 27/2678; H04W 64/00

(57) ABSTRACT

An apparatus and system are described for joint communication and sensing. A sensing frame structure design is described within the next generation cellular system frame and numerology, as are the use of Positioning Reference Signals (PRS) for sensing with various expansions and adaptations. Speed/direction related measurements of a user equipment (UE) allow velocity estimation in localization/positioning. Specifics of sequence-based signal generation and initialization in which a Gold sequence is used are also described.

### PRIORITY CLAIM

This application claims the benefit of priority to U.S. Provisional Patent Application Ser. No. 63/407,415, filed Sep. 16, 2022, and U.S. Provisional Patent Application Ser. No. 63/414,753, filed Oct. 10, 2022, each of which is incorporated herein by reference in its entirety.

### BACKGROUND

The use and complexity of next generation (NG) networks, which include 5^{th} generation (5G) and sixth generation (6G) networks among others, has increased due to both an increase in the types of user equipment (UE) using network resources as well as the amount of data and bandwidth being used by various applications, such as video streaming, operating on these UEs. With the vast increase in number and diversity of communication devices, the corresponding network environment has become increasingly complicated. As expected, a number of issues abound with the advent of any new technology, including complexities related to joint communication and sensing.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a sensing block structure in accordance with some embodiments.

FIG. 4 illustrates a new radio (NR) positioning reference signal (PRS) resources configuration in accordance with some embodiments.

FIG. 5 illustrates PRS repurposing for sensing in accordance with some embodiments.

FIG. 6 illustrates a process of determining joint communication and sensing (JCAS) configuration information in accordance with some embodiments.

FIG. 7 illustrates NR numerologies and frame structure in accordance with some embodiments.

FIG. 8 illustrates sensing and communication blocks in accordance with some embodiments.

FIG. 9 illustrates a process of providing a sensing signal message in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

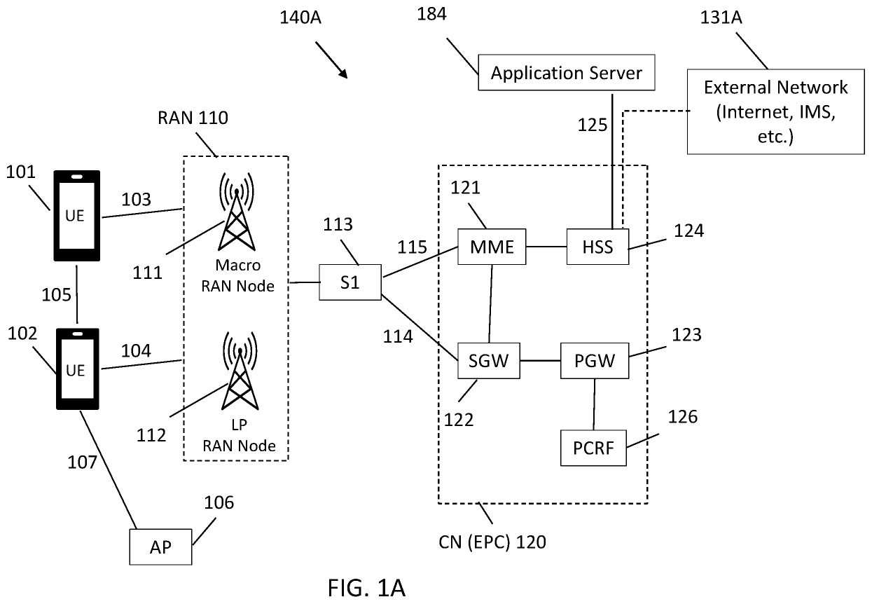

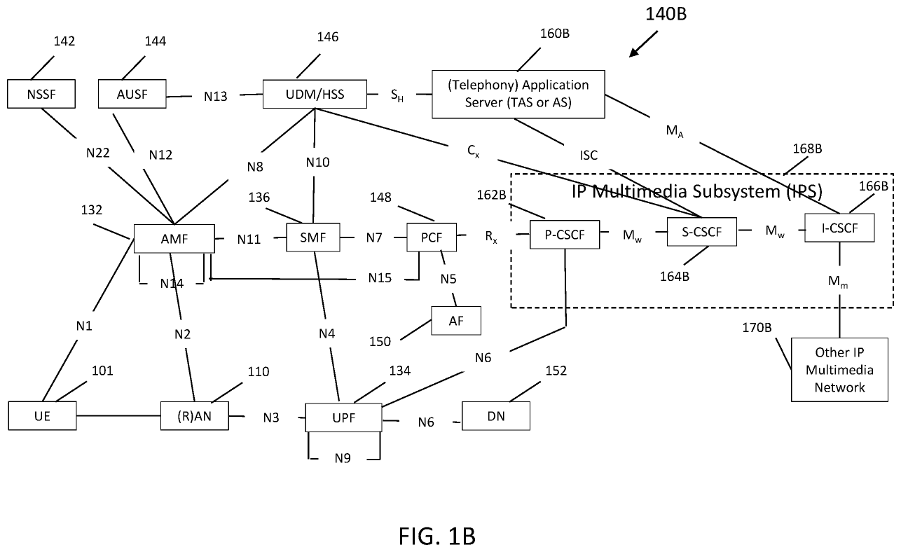

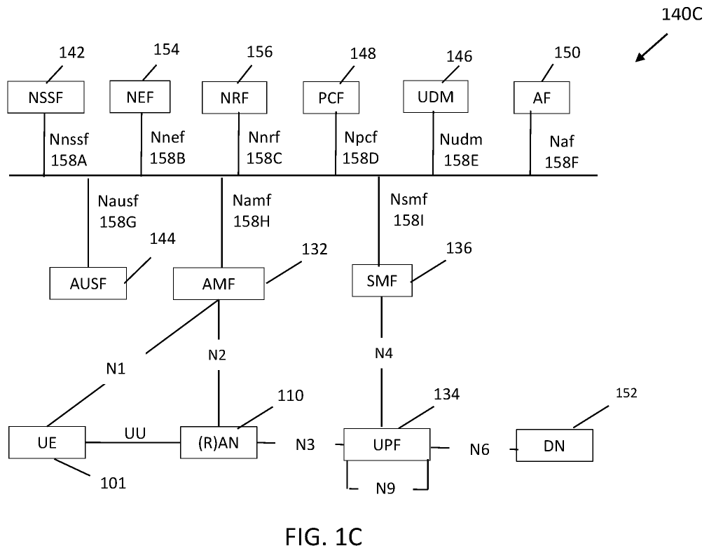

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for ULE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

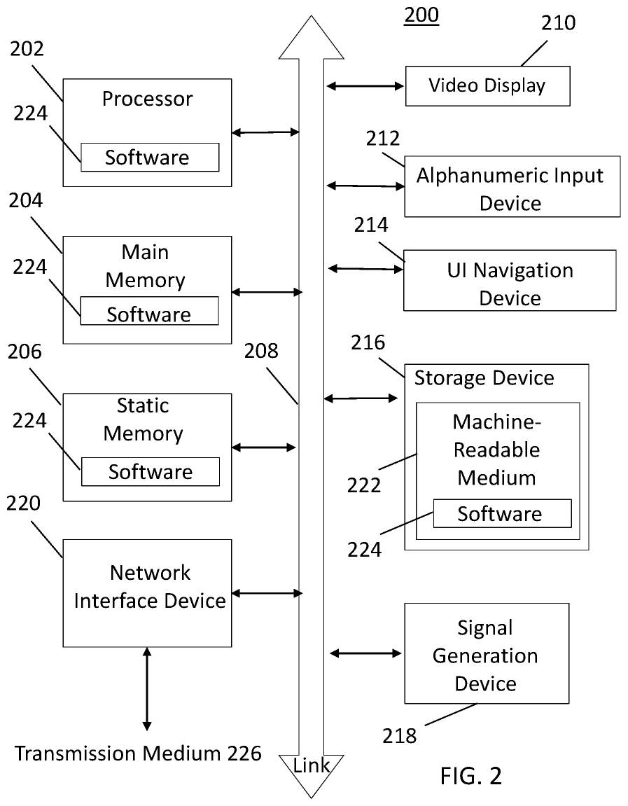

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.1 lbd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.1 lbd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, a design aspect of cellular-based joint communication and sensing (JCAS) is the enablement of sensing functionality within the OFDM framework. Sensing may be performed to obtain measurements that may be useful to estimate features such as range, velocity, and motion of objects in an area of interest. Measurements obtained with sensing may be used to enable applications such as presence detection (of a UE or other objects) and gesture classification, among others. This functionality may include the proper definition and configuration of the numerology and sensing frame structure and should be properly aligned within the boundaries of an existing communication frame. The functionality also employs efficient assignment of resources, which considers various design factors involving both communication and sensing performances. Extension of positioning reference signal to realize desired sensing capabilities and key performance indicators (KPIs) are described.

### Potential Sensing Frameworks/Architectures in Cellular Systems

Various gNB-based and UE-based sensing scenarios can exist in a cellular framework, to enable different sensing application and use cases. For example, the following cases can exist:
Case 1: the gNB sends the sensing radio signal and receives/measures/processes its reflections from objects/environment, in time, frequency, and spatial/angular domains. If the same gNB also receives/measures/processes the reflected signal, the scenario may be called a gNB-based monostatic sensing mode, and if other gNB(s) are involved in receiving, measurement/processing, it may be called a gNB-based bi-static (multi-static) sensing mode by cooperative network nodes.
Case 2: the gNB sends the sensing radio signal and the UE receives/measures/processes its reflections (bi-static sensing mode).
Case 3: the UE sends sensing radio signal and the same or different UE(s) receives/measures its reflections (corresponding to UE-based monostatic and bi/multi-static sensing modes, respectively).

For cases 1 and 2, sensing signal can be based on a downlink (DL) PRS signal (or an extended or adapted version of DL PRS), or a newly designed sensing signal. In addition, cases 1 and/or 2 may be combined with the case in which the UE receives/measures the gNB radio signal for positioning purposes, e.g., when the gNB signal is based on a DL PRS signal (described below). As can be seen from the above cases, sensing may use transmission/reception from multiple nodes to perform coordinated environment or neighborhood perception by multiple gNBs and/or UEs.

The discussions herein are not limited to a particular sensing architecture or use case and are kept general to the possible extent. Thus, a sensing device may be or include a NodeB (e.g., gNB) or UE, among others. However, a gNB-based sensing is the primary focus herein whenever a particular sensing scenario and architecture is assumed. Further, while the air-interface signal design can be applicable to monostatic or bi/multi-static sensing architectures, the focus is on the monostatic case when a particular architecture is assumed. Similarly, the contents of the current disclosure are not limited to a particular use case family. However, a smart transportation use case and its corresponding applications may be considered (sensing use cases together with a set of baseline sensing KPI requirements were adopted by Next G Alliance Technology Working Group (NGA TWG) report, section 3.5 on JCAS) when a particular use case is assumed. For example, in dimensioning the sensing block, speed requirements for traffic monitoring use cases are fulfilled (while lower and higher speeds are also accommodated). However, such dimensioning does not cause any loss of generality in the disclosed approaches.

### Uu Interface Impact

The Uu interface, or air interface between the gNB and UE, can be impacted by the sensing structure for each these cases. gNB-based sensing (which is based on the gNB signal), by nature, and on its own, may not impact the Uu interface; particularly, as the sensing signal may not concern any UE, for reception or transmission. On the other hand, to better manage the resource efficiency, as well as transmission/reception (TX/RX) of other signals (communication signals) to/from the UEs, in a joint communication and sensing system, there are potential impacts on the Uu interface. For example, the sensing signal may be designed to be backward compatible in the sense that it can also be used for the UE positioning purposes, or it may be possible to extend the PRS for the purpose of sensing as well. Particularly, the DL PRS has attributes that are close to what is expected for a signal being used for sensing. As such, with some adaptations/extensions to the PRS, sensing using the PRS can also be enabled. It would be efficient to enable gNB-based sensing and UE positioning using the same PRS signal or an extension of the existing PRS signal, as described herein. The example of reusing PRS for the purpose of sensing, shows limited Uu impact may result, to handle better efficiency in use of system resources, etc.

### Dimensioning Attributes and Properties of Air-Interface Signal Used for Sensing

In order to enable sensing functionality addressing different use cases (UCs) with corresponding sensing KPI requirements, time domain and frequency domain attributes may be proscribed for wireless signals used for sensing. Such attributes determine the underlying numerologies, frame structures, as well as the physical resource assignments and patterns. These aspects are discussed below.

### Baseline Sensing Objectives

A signal used for sensing should enable the following objectives:

Detection, and estimation of the range, velocity and/or angle of targets via baseline receiver (Rx) processing (e.g., 2D map/periodogram) of reflected radar signals (within certain ranges and with certain resolution and accuracy).

Efficient flexible multiplexing between communication and sensing: baseline solution for JCAS is to enable time domain multiplexing (TDM) of communication and sensing as the default multiplexing mode, considering communication transmission opportunity availability, comm latency, resource efficiency, etc.

Efficient handling of interference between sensing signals of different sources and between communication and sensing.

Such objectives may involve specific time/frequency attributes and determination of key sensing signal properties and parametrization. Resource allocation is one aspect in enabling sensing detection processing, as will be discussed below.

### Core Sensing Detection Principles

Range detection principle: A delay shifts the echo signal in time. How long it takes the radio signal to return is a measure of the distance of the reflecting object. For an OFDM waveform, the time shift results in a phase difference between the actual and the delayed echo signal. This principal impacts/determines both numerology and the frequency domain structure/pattern of the signal used for sensing.

Speed detection principle: For a moving object an echo will not have same wave frequency as the original signal due to the Doppler shift. The frequency change is a measure of the object's speed. Based on how much the frequency changes, a radar can calculate how quickly a target is moving toward it or away from it. This translates into a Nyquist sampling rate, i.e., how frequent the signal is transmitted, or equivalently, defining the maximum time interval between consecutive occurrences of sensing signal repetitive transmitted symbols (e.g., for a given direction) called the symbol repetition interval (SRI), in order to enable a maximum detectable velocity. This impacts both numerology and time domain signal structure/pattern of the signal used for sensing.

Angular detection principle: dependent on TX/RX antenna array/architecture/beamforming and the particular processing algorithm used, a radar can distinguish objects at the same range/velocity but reflecting the radio signal from different angles.

Baseline general detection processing principle considered for signal dimensioning

Range/Doppler detection principles are common between different detection algorithms. The baseline RX processing typically consists of two dimensional fast Fourier transform (2D-FFT) for extracting echo delay (range) and Doppler (velocity)—a 2D map/periodogram. Peaks of the 2D map may be used to determine the detected distances/velocities to targets. Steep narrow main lobes in a 2D map enable low-complexity hardware and signal processing in RXs for estimating sensing parameters (delay, Doppler frequency, angle of arrival (AoA).

### OFDM-Based Sensing

As the baseline, OFDM-based sensing is preferred for cellular JCAS compared to sensing based on other waveforms, from the following perspectives:

Cellular systems already operate with OFDM waveform to a large scale, with high capability to carry data, high communication performance, high user multiplexing capability, high processing capability to support MIMO and BF, etc.

It allows good radar performance and capability for extracting sensing information, with acceptable processing complexity.

The self-interference mitigation to realize full-duplex operation is expected to be handled properly, in future cellular system base stations (BSs) (and even feasible for some current BSs). On the other hand, it is noted that for the UE, full-duplex is likely feasible in a sub-band sense, where a given band is dynamically split up into UL and DL sub-bands, while full-duplex support on the same sub-carriers as use by OFDM for JCAS may be developed at a later time.

OFDM allows good compatibility with existing slot timing structure, allowing interspersing of communication symbols and sensing symbols.

Compatibility with existing OFDM allows considerable hardware (HW) re-use (i.e., FFT/IFFT, etc.).

### OFDM Baseline Radar RX Processing

In a typical OFDM radar RX processing,

The RX divides the received modulation symbols by the known TX modulation symbols, so that a (noisy) time-variant frequency-selective channel frequency response (CFR) is obtained. The impact of random data removed by element-wise division between the transmitted OFDM symbols and the received echoes may be determined.

For OFDM, to estimate range and speed of the object, a received signal in time-frequency domain is transformed to the Doppler-delay domain by applying FFT/IFFT on received signal to generate a 2D complex periodograms for each virtual antenna port: an IFFT of the CFR, along the subcarrier dimension provides time domain impulse response to estimate the range (Range FFT size); an FFT in the time direction across multiple OFDM symbols provides the Doppler spectrum to estimate the Doppler (Doppler FFT size, k).

Constant false alarm rate (CFAR) processing obtains the bins in the average amplitude/power periodogram that potentially contains targets.

Angle resolution (spatial resolution) processing on complex periodograms outputs potential targets with their corresponding range, Doppler, and angular information.

The range and Doppler introduced by a reflecting object have orthogonal influence on modulation symbols. Thus, processing in range and Doppler become orthogonal, which has the benefit that range accuracy is not negatively impacted by limited Doppler measurement accuracy. Hence, it is possible to recover range and Doppler independently with a suitable processing algorithm. It is also noted that the orthogonality holds if the observation duration (sensing block) is sufficiently short that reflecting object remains within one range resolution cell (to avoid range migration problem).

The explicit channel knowledge (obtained in the 1^{st} step) can also be beneficial for advanced signal processing purposes, e.g., for training artificial intelligence/machine learning (AI/MIL) systems on detection of presence and shape of objects.

Basic relationships between sensing range and speed-related metrics and the OFDM system parameters:

Range resolution Δd is the minimum distance to distinguish between two targets with same velocity (Doppler shift) and is inversely proportional to the total minimum transmit bandwidth (BW):

$$Δ d = {c}_{0} / ( 2. BW ) ,$$

where c₀ is the speed of light.

Velocity resolution Δv is the minimum velocity to distinguish between two targets with same range (phase shift) and is inversely proportional to the total frame duration used for sensing processing:

$$Δ v = {c}_{0} / ( 2 {f}_{c} \times sensing frame duration ) ,$$

where the sensing frame duration is the total integration time span over which the sensing signal extends when computing the Doppler profile, and f_{c} is the RF carrier frequency (narrow band OFDM is assumed, where OFDM BW«RF frequency).

Maximum detectable velocity vₘₐₓ is inversely proportional to the spacing between time domain repetitions of the sensing symbol transmitted in a particular direction (periodic time spacing defined by T_{SRI}), within span of sensing frame:

$${v}_{max} \leq {c}_{0} / ( 4 {f}_{c} \times {T}_{S R I} ) .$$

Particularly, repetitions within a sensing frame enable Doppler estimation per beam direction. As such, the maximum spacing between two consecutive sensing symbols used for transmission in a given direction, within a sensing block (frame), is defined by T_{SRI}. This can be seen as a Nyquist sampling rate for the maximum unambiguous speed detection. Besides this condition, there are also other limits on reliably/robustly detectable maximum speed, e.g., particular to OFDM-based sensing, etc. As such, in one embodiment, the maximum detectable speed is to meet the SRI Nyquist rate, keep inter-carrier interference (ICI) tolerable (Max Doppler frequency should be 1/m of the subcarrier spacing (SCS), where an m of about 10 is a typical choice), and avoid range migration:

$${v}_{max} \leq Min ( \frac{{c}_{0}}{4 {f}_{c} {T}_{SRI}} , \frac{{c}_{0} \times SCS}{2 \times m \times {f}_{c}} , \frac{Δ d}{k \times {T}_{SRI}} ) .$$

Max detectable range in an OFDM-based sensing system is determined based on two main conditions:

To avoid aliasing, the largest unambiguously measurable range (for reliable radar operation) is limited by the inverse of SCS (i.e., the symbol duration T):

$${d}_{max , unambig} \leq {c}_{0} / ( 2 \times SCS ) .$$

Compared to the classic correlation-based method where any distance is measurable in principle, in modulation symbol-based processing, a frequency domain (FD) signal is inherently discretized and the maximum unambiguous range corresponds to the distance that the signal travels during the elementary OFDM symbol duration T. For ranges less than the maximum unambiguous distance (i.e., d<d_{max, unambig}), there is no ambiguity in range detection due to aliasing. But two targets at d and d+d_{max, unambig} cannot be distinguished.

The maximum ISI-free distance:

$${d}_{max , no - ISI} \leq {c}_{0} {T}_{cp} / 2 ,$$

where T_{cp} denotes the cyclic prefix duration. This condition is due to the channel multipath propagation physical limits, to avoid ISI, and preserve orthogonality between modulation symbols. The guard interval duration is related to the maximum expected multipath delay to allow fully compensating multipath propagation effects and ensure no ISI. This guarantees no de-orthogonalization in the received matrix. Particularly, if the received signal is delayed for more than the cyclic prefix (CP), the modulation symbols are aligned incorrectly and de-orthogonalization occurs. But if the delay is less, the symbols are not shifted too far from their original position and can correctly be demodulated. Further, a proper choice of CP ensures an element-wise division to divide the correct elements.

In some embodiments, d_{max, no-ISI} is the limit within which objects can be detected with high quality. Particularly, there is a graceful degradation in range detection performance, if the target is beyond the CP limit. ISI reduces the peak to noise ratio, which degrades as moving away from CP limit. However, d_{max, unambig} is the maximum clearly measurable range and is an absolute physical limit not to be exceeded. As such, in one embodiment, for a practical system, dimensioning of the CP duration for a given subcarrier spacing (SCS) may be used to achieve ISI free detection for the maximum desired distance, and the system tolerates non-ideal performance up to the distance:

$$n \times {c}_{0} {T}_{cp} / 2 ,$$

where the value n is properly selected (considering the environment to be sensed, transmit power, etc.) such that objects at distance d, where d meets the following conditions:

$${d}_{max , no - ISI} \leq {c}_{0} {T}_{cp} / 2 \leq d \leq n \times {c}_{0} {T}_{cp} / 2 \leq {d}_{max , unambig} = {c}_{0} / ( 2 \times SCS )$$

can still be detectable (without aliasing), but with some potential reduction in performance (in terms of constant false alarm rate (CFAR), the desired signal-to-noise ratio (SNR), etc.). Based on preliminary evaluations with simplified assumptions regarding the environments, n<~5 may still be a reasonable choice (while n=1 results in ideal ISI-free performance).

In some embodiments, these relationships help determine the fundamental system parameters. Particularly, parameters of sensing signal including a minimum BW, a minimum duration of sensing signal, a minimum/maximum repetition periodicity, and a minimum duration of the sensing frame, are designed such that the above sensing requirements are met for a given use case scenario. Table 1 summarizes the relationship between system parameters and sensing KPIs.

TABLE 1
Relationship between system parameters and sensing KPIs

| | Relationship to | |
|---|---|---|
| Design parameter | sensing metric | Note |
| Min required bandwidth | c/(2Δd) | |
| Min required sensing | c/(2f_{c}Δν) | Parameters can |
| frame duration | | be shown in units |
| | | of OFDM |
| | | symbols |
| Min time domain gap | 2dₘₐₓ/c | For OFDM, this |
| between sensing | | is min CP |
| allocations (min guard | | |
| interval) | | |
| Min frequency domain | >>4f_{c}νₘₐₓ/c | For OFDM, this |
| gap between sensing | (max Doppler freq.) ≈ | is min SCS and |
| allocations | 20f_{c}νₘₐₓ/c | the max Doppler |
| | | frequency |
| | | is ~10% |
| | | of SCS |
| Max time domain | c/(4f_{c}νₘₐₓ) | |
| gap/spacing between | | |
| sensing allocations (SRI) | | |
| Max freq. domain | c/2dₘₐₓ | |
| spacing between sensing | | |
| allocations | | |

### Statistical Properties/Structure of the Sensing Signal in Time and Frequency Domains

As indicated above, the parametrization, numerology, frame structure, and TD/FD resource mapping/dimensioning of the signal used for sensing (either a specific sensing signal or a DL communication signal) is driven by range and velocity resolution, and respective unambiguous maximum detectable values, as well multiplexing of communication and sensing. More accurately, dimensioning of numerology (selection of SCS and symbol/CP duration), and time-frequency attributes, resource allocation, and statistical properties (which is an aspect in enabling the desired detection processing) of sensing signal is primarily driven by the above. Further, all the OFDM system parameters (e.g., BW, SCS, number of subcarriers, CP duration, symbol duration, number of OFDM symbols) can be derived from the above. For example, while the sensing signal time domain repetition, as well as the SCS, define the maximum detectable speed, the total time span duration (i.e., the integration time—sensing block) defines the achievable speed resolution. On the other hand, the SCS and the CP duration (i.e., numerology) define the maximum detectable range, while the bandwidth (total frequency span) defines the range resolution.

### Time Domain Sensing Resources (Attributes Patterns) and System Parameters

To ensure a predetermined sensing performance, a time span and time spacing are defined for the signal used for sensing. Two time domain resource assignment properties for sensing signal to enable Doppler processing are:

Integration time span over which sensing signal extend when computing Doppler profile:

$$Sensing block ( or sensing frame ) = {c}_{0} / ( 2 {f}_{c} Δ v ) ,$$

which is inversely proportional to velocity resolution and carrier frequency. In sensing frame design, the sensing block duration is an integer number (k) of SRI durations, i.e., k×T_{SRI}. k is the size of FFT operation performed in Doppler processing.

The maximum time spacing between sensing symbols within span of sensing block to enable Doppler estimation per beam direction defined by symbol repetition interval (SRI):

$${T}_{SRI} \leq \frac{{c}_{0}}{( 4 {f}_{c} {v}_{max} )} ,$$

which is inversely proportional to the maximum detectable speed and carrier frequency. As also mentioned earlier, this can be seen as a Nyquist sampling rate for maximum speed detection. Besides this factor, there are also other limits on the maximum detectable speed. The maximum detectable speed is to meet the SRI Nyquist rate, ICI condition (Max Doppler frequency should be ~10% of SCS), and range migration:

$${v}_{max} \leq Min ( \frac{{c}_{0}}{4 {f}_{c} {T}_{SRI}} , \frac{{c}_{0} \times SCS}{20 \times {f}_{c}} , \frac{Δ d}{k \times {T}_{SRI}} ) .$$

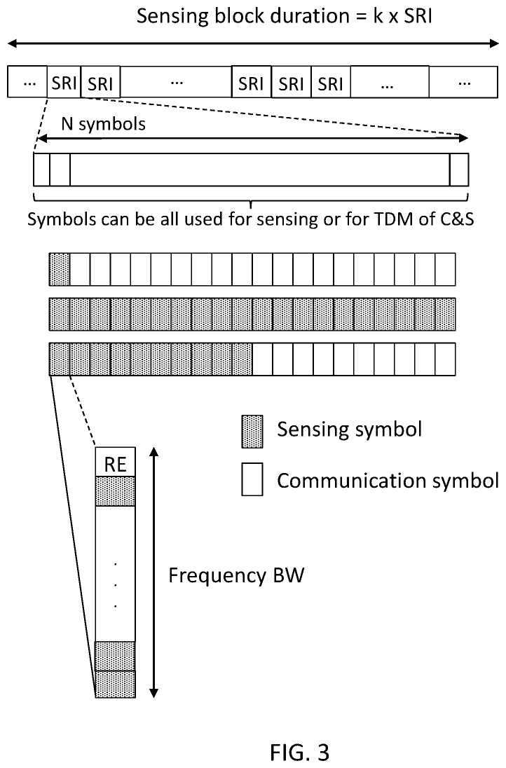

These two properties allow the sensing signal to perform a single task of sensing (without additional processing gains). FIG. 3 illustrates a sensing block structure in accordance with some embodiments. In FIG. 3, sensing uses at least symbols at SRI boundaries; other symbols within the SRI may be used for sensing or for TDM of communication and sensing. Any time repetition and/or block duration beyond the minimum values results in further proc gain, improving SNR. It is also noted that these attributes determine the basic allocation scheme in the context of sensing using a single beam. These concepts can then be extended to the case of multi-beam operation.

Another time-related system parameter is related to the sensing range. As discussed earlier, the sensing range can be translated into the CP duration (T_{CP}). For ideal range detection performance, the CP duration should be on the order of 2x(maximum range)/c₀. The NR CP in frequency range1 (FR1) is long enough to cover ranges beyond 180-350m. As such, FR1 supports longer range UCs with the same CP and OFDM symbol durations for communication and sensing symbols. Also, in FR1, a useful symbol duration is large compared to the orders of CPs desired for sensing ranging (low CP loss). It is noted that, in general, between the sensing numerology and the communication numerology, only CP (hence, total symbol duration) may be limited to be different; other than that, SCS, etc. are all aligned between the communication and sensing systems. For FR2, supporting a unified symbol/CP duration between communication and sensing may not be possible for higher SCSs, depending on the UC maximum range limitations. Particularly, FR2 can support shorter range UCs with the same CP and OFDM symbol duration for sensing and communication and longer-range UCs with different CP and OFDM symbol durations for sensing and communication.

### Frequency Domain Sensing Resources (Attributes Patterns) and System Parameters

The translation of the sensing limitations into signal properties in the frequency domain are now described. Particularly, the frequency domain resource assignment for a sensing signal to enable a single sensing task should meet the following condition:

The minimum signal bandwidth is inversely proportional to the supported range resolution:

$$\frac{{c}_{0}}{( 2 Δ d )} .$$

As such, sub-meter Δd is achievable with a bandwidth>150 MHz. Accordingly, FR1 may impose potential compromise in range resolution, which may be addressed by enabling use of carrier aggregation to provide extended bandwidth for sensing.

In terms of the use of subcarriers within the assigned bandwidth (BW), a FD comb structure reduces the maximum unambiguous range (since it increases effective SCS). On the other hand, as discussed earlier, range detection performance is limited by CP limitation as well, and CP-based range is normally much smaller than the maximum unambiguous range. As such in one embodiment, in a practical system, the largest integer value m_{comb} for which n×C₀T_{cp}/2 is less than 1/m_{comb}×(the maximum unambiguous range, i.e., n×C₀T_{cP}/2≤c₀/m_{comb}(2×SCS)) is derived, e.g., for some systems, even 5 times CP range is about (⅓)×(maximum unambiguous range). Then, the comb size can be selected as a number less than or equal to m_{comb}. For example, for the aforementioned system, an FD comb of size m_{comb}=2 or 3 can be supported. Different sets of subcarriers (e.g., realized with different frequency domain RE offsets) can then be used to handle (at least to some extent) the inter-cell interference from the signal used for sensing from nearby BSs. In general, there are different approaches to mitigate interference, e.g., by leveraging multiplexing in time, frequency, code, and/or sequence domain. For effective handling of interference, a combination of different approaches may be accommodated and supported by the design.

Another frequency-related system parameter is related to the sensing speed limitations. As discussed earlier, the sensing speed limitations are also related to the SCS. Particularly, the SCS have different implications and tradeoffs in terms of sensing. On the one hand, the SCS is inversely proportional to the maximum unambitious detectable range. Larger SCS may allow detection of higher Doppler shifts and faster moving targets. For acceptable inter-carrier orthogonality (for ICI mitigation), the SCS should be larger than ~10×Doppler frequency

$$( about \frac{20 \times {f}_{c} \times {v}_{max}}{{c}_{0}} ) .$$

On the other hand, as the SCS is increased to support a desired range, CP loss increases. Usually, larger SCS are available for higher carrier frequencies, which support shorter OFDM symbol and CP durations, resulting in shortened sensing ranges.

As discussed below, for different SCS values, the choice of SRI and sensing frame duration may be determined separately, and achievability of certain ranges can also be assessed depending on CP, etc.

### Sensing Frame Structure Design

In order to come up with the sensing frame structure design from the time and frequency domain attributes, the following high-level procedural steps have been followed: Estimates of different system parameters are derived from the KPIs. Then, the values for system parameters are fine-tuned based on the derived estimates, considering practical cellular frame structure and numerology parameters. The resulting achievable KPIs, as well as achievable SNR (from link budget), can then be calculated.

Examples of how a sensing frame structure can fit in the cellular system frame and numerology are provided. Accordingly, the following example SRI values and Doppler FFT sizes (and hence, sensing frame structure and durations) are also proposed to support highest possible capabilities for velocity estimation under different limitations, and to meet reasonably fine velocity resolutions, while keeping the design as simple as possible (without compromising supported sensing performance).

### Example 1

For example, SRI is defined to occur either at a half-slot-rate, full-slot-rate, or double-slot-rate for different maximum desired speeds (depending on the use case). The resulting exact supported maximum speed and speed resolution can then be determined, also based on the carrier frequency.

For all carrier frequencies in FR1, following SRI durations (in number of OFDM symbol (OS)) and Doppler FFT sizes (k) are to be supported:

$$For SCS = 15 KHz , \{ {T}_{SRI} , k \} = \{ 7 OS , 32 \} , \{ 7 OS , 64 \} ;$$

$$For SCS = 30 KHz , \{ {T}_{SRI} , k \} = \{ 14 OS , 32 \} , \{ 14 OS , 64 \} , \{ 7 OS , 64 \} , \{ 7 OS , 128 \} ; and$$

$$For SCS = 60 KHz , \{ {T}_{SRI} , k \} = \{ 28 OS , 32 \} , \{ 28 OS , 64 \} , \{ 14 OS , 64 \} , \{ 14 OS , 128 \} .$$

These result in a sensing block duration=k×T_{SRI}=16, 32 msec.

For FR2, following SRI durations and Doppler FFT sizes (k) to be supported:

For SCS=60 KHz, for all carrier frequencies in FR2, {T_{SRI}, k}={7OS, 64}, {70S, 128}, which results in a sensing block duration=k×T_{SRI}=8, 16 msec. For frequencies<30 GHz in FR2, {T_{SRI}, k}={14OS, 32}, {140S, 64}, {140S, 128} are also supported, resulting in a sensing block duration=8,16.32 msec. For frequencies>50 GHz in FR2, {T_{SRI}, k}={7, 256} is also supported, resulting in a sensing block duration=32 msec.

For SCS=120 KHz, for all carrier frequencies in FR2, {T_{SRI}, k}={14OS, 64}, {140S, 128} are supported, resulting in sensing block duration=8, 16 msec, and {T_{SRI}, k}={7OS, 64}, {7OS, 128} are supported, resulting in sensing block duration=4, 8 msec. For carrier frequencies>50 GHz in FR2, k=256 is also supported, resulting in sensing block duration=32, 16 msec for T_{SRI}=14, 70S, respectively.

The number of OFDM symbols in the SRI may provide a good balance between the maximum detectable speed, the sensing repetition gain (the total Doppler processing gain, for a certain sensing block is 10 log10(Doppler FFT size)+10 log10(number of OFDM symbol within SRI)), the flexibility/capability to support multiplexing between sensing and communication, the field-of-view (FoV) coverage (depending on the desired number of beams), and the beamwidth. Further, as can be seen from the above values, the Doppler FFT sizes are generally smaller in FR1, which involves fewer radio frames for sensing and less limitation and unavailability for communication. In addition, while larger Doppler FFT sizes may also be supported (e.g., to provide finer Doppler resolution and/or higher processing gain), longer sensing frame durations resulting from large Doppler FFT sizes may result in range migration issue in the range-Doppler image. This may involve proper handling to avoid performance degradation.

Sensing UCs and services in a JCAS system may also support different values for SRI duration and/or Doppler FFT size than the above proposed values. The above values provide examples on how a sensing frame structure can fit in the cellular system frame and numerology.

In all above cases, CP durations that are the same as in NR are also used for OFDM symbols for sensing. When different CP (and hence symbol duration) between communication and sensing (which may be motivated if longer sensing ranges (>100m) with higher SCSs in FR2 are to be supported) are used, proper alignment between sensing block durations and communication slot boundaries is to be obtained. Given that the normal CP of NR supports up to about 90m ISI-free range detection, for 120 kHz SCS, and considering the fact that for mmWave, the power range (link-budget) may not allow more than 100m (even 100m for some practical deployments may be too far, e.g., rooftop looking around the block), support of longer-range UCs with FR2 may not be fully justified (especially, as the longer-range UCs can be supported with FR1 with less complications). Still, it can be beneficial for the specification to allow support of different sensing symbol than communication symbol for higher SCSs in FR2, as exemplified next.

### Example 2

Future cellular systems that support JCAS may allow configurable CP lengths for SCS>120 KHz. This enables longer-range UCs such as smart transportation, etc., over FR2 and beyond. For example, for SCS=60 KHz, the sensing OFDM symbol and CP duration can be equal to those of the communication. However, for SCS=120 KHz, while the communication OFDM symbol duration is 8.92us, the sensing OFDM symbol duration can be configurable between {8.92, 8.92+X} us, where X can be selected depending on the desired range. For example, X=0.2us results in OFDM symbol duration of 9.12us and considering the same useful symbol duration across different total OFDM symbol durations (due to the same SCS), this means a CP duration of 0.79us for the sensing (compared to CP duration of 0.59us in NR SCS=120 KHz), accommodating up to about 120m ISI-free range detection. For SCS=480 KHz, while the communication OFDM symbol duration is 2.23us, the sensing OFDM symbol duration can be configurable between {2.23, 2.23+X} us, where X can be selected depending on the desired range. For example, X=0.63us results in OFDM symbol duration of 2.86us and considering the same useful symbol duration across different total OFDM symbol durations (due to the same SCS), this means a CP duration of 0.79us for the sensing (compared to CP duration of 0.146us for communication for SCS=480 KHz), accommodating up to about 120m ISI-free range detection. However, there is a significant increase in terms of the CP loss for this case.

Further, Table 2 provides the system parameters related to frame structure, which impact the range detection. While these calculations are based on the existing NR SCSs and CP durations, JCAS support in the next generation of cellular networks, may not preclude defining longer OFDM symbols and/or CP values for sensing purposes.

TABLE 2
System parameters related to range detection

| | | | NR | Max | | | Sensing | Max | | |
|---|---|---|---|---|---|---|---|---|---|---|
| | | CP | OF | ISI- | Max | | symbol | ISI- | BW | |
| | | duration | DM | free | unambig. | | [us] | free | [MHz] | Range |
| | SCS | (TCP) | symbol | distance | Distance | Slot | (CP = | distance | (w/o | resolution |
| FR | [kHz] | [us] | [us] | (c*Tcp/2) | (c/(2*SCS)) | [ms] | 0.78125) | (c*Tcp/2) | CA) | (c/2*BW) |
| FR1 | 15 | 4.69 | 71.36 | 703.5 m | 10 km | 1 | 71.36 | 703.5 m | 100 | 1.5 m |
| | | | | | | | (4.69) | | | |
| FR1 | 30 | 2.34 | 35.67 | 351 m | 5 km | 0.5 | 35.67 | 351 m | 100 | 1.5 m |
| | | | | | | | (2.34) | | | |
| FR1& | 60 | 1.17 | 17.84 | 175.5 m | 2.5 km | 0.25 | 17.84 | 175.5 m | 100 | 0.375 m |
| 2 | | | | | | | (1.2) | | &400 | |
| FR2 | 120 | 0.59 | 8.92 | 90 m | 1.25 km | 0.125 | 9.11 | 117 m | 400 | 0.375 m |
| | | | | | | | (0.78125) | | | |
| FR2 | 480 | 0.146 | 2.23 | 34.5 m | 0.3125 km | 0.03125 | 2.86 | 117 m | 400 | 0.375 m |
| | | | | | | | (0.78125) | | | |
| FR2 | 960 | 0.073 | 1.115 | 10.94 m | 0.156 km | 0.015625 | 1.82 | 117 m | 500? | 0.3 m |
| | | | | | | | (0.78125) | | | |

For higher carrier frequencies within FR2, and for higher maximum supported speeds (e.g., +/−200 km/h), even SCS=120 KHz does not meet the Doppler condition mentioned earlier for acceptable inte-carrier orthogonality. Larger SCS allows detection of higher Doppler shifts and faster moving targets. On the other hand, as SCS is increased, in order to support a given range, CP loss as a percentage of symbol size increases. These aspects should be carefully considered to justify support of higher SCSs (e.g., 240 KHz and 480 KHz for FR2) for certain sensing use cases.

### Observations on Supported UCs Over FR1 and FR2

Based on the above analysis, overall observations on different UCs supported over FR1/FR2 are as follows:

FR1 supports mid-high speeds (about 120 km/h) and/or long ranges (max 180-350m) with the same CP and OFDM symbol length between communication and sensing. FR1 can support a range resolution at best about 0.5m (with contiguous carrier aggregation (CA)). FR1 is supported for any sensing UC with longer range or higher angular resolution cases (FR1 supports larger arrays with more multiple input multiple output (MIMO) layers in future cellular system generations, which may lead to high angular resolution and can be more impactful at longer sensing ranges). For example, a NG FR1 BS may start with 16×16 MIMO as a minimum, supporting an angular resolution of <1′. On the other hand, higher SNRs come from large number of chains, using fewer repetitions for a set processing gain, leaving more resources for communication.

Using the sensing frame structure, lower carrier frequencies in FR2 are suitable to support either (mid-range, mid speed) [with 60 KHz] or (mid-range, high-speed) [with 120 KHz] or (low-range, very-high-speed) [with SCS>120 KHz]. For example, FR2 (<30 GHz) with SCS=60 kHz is only suitable for UCs that do not use a maximum speed higher than 80 km/h, while SCS=120 kHz is suitable for UCs with a maximum speed about 150 km/h.

Using the sensing frame structure, higher carrier frequencies in FR2 are suitable to support either (mid-range, low-speed) [with 60 KHz] or (mid-range, mid-speed) [with 120 KHz] or (low-range, high-speed) [with SCS>120 KHz]. For example, FR2 (>30 GHz) with SCS=60 KHz is suitable for a maximum speed<50 km/h, and with SCS=120 KHz is suitable for UCs that do not use a maximum speed higher than about 120 km/h.

Feasibility analysis to use existing NR signals for sensing

In the previous sections, the sensing limits, sensing signal numerology, time and frequency attributes, and sensing frame structure aspects are formulated. Considering such characteristics, NR existing DL signals can be assessed in terms of the feasibility of reusing any such signal for sensing. Different signals have different statistical properties, leading to different sensing performances, which may or may not meet the use case KPIs. Further, any design aspects that may be also extendable and beneficial for the sensing can also be investigated. Particularly, high-level aspects to be studied from existing signal designs include time, frequency, spatial resource properties and structures, as well as aspects with respect to interference handling. Table 3 summarizes different NR DL signals and their main attributes and/or drawbacks for the purpose of sensing.

TABLE 3
Different NR DL signals and their main
drawbacks for the purpose of sensing

| | | Signal | | |
|---|---|---|---|---|
| | | Pattern in | | |
| Type of | Signal Pattern | Frequency | Signal | Signal |
| Signals | in Time Domain | Domain | Correlation | Values |
| Reference | DMRS & PT- | Regular | Typically, | Known |
| Signals: | RS: random, | comb | orthogonal | and fixed |
| DMRS, | irregular and | structure | (between | |
| PT-RS, | varying length | (allocation | different | |
| CSI-RS, | (depending on | dependent), | ports (CSI- | |
| TRS | data payload) | usually | RS) or UEs | |
| | CSI-RS/TRS: | very sparse | (DMRS) to | |
| | more regular | and limited | support | |
| | | BW - | multiuser | |
| | | DMRS can | MIMO) | |
| | | have higher | (Orthogonal | |
| | | density | over time, | |
| | | compared | and can have | |
| | | to others, | FD and | |
| | | but | spatial | |
| | | irregular in | domain for | |
| | | time | different | |
| | | | UEs) | |
| SSBs | Short and less | Sparsely | Orthogonal | Known |
| | frequent | distributed, | over smaller | and fixed |
| | | using | spatial layers | |
| | | 20 resource | | |
| | | blocks | | |
| Positioning | Repetitive/regular | Regular | Orthogonal | Known |
| reference | over certain | comb and | over time, | and fixed |
| signal | duration | can extend | frequency. | |
| | | over entire | Pseudo- | |
| | | system BW | orthogonal | |
| | | | over | |
| | | | sequence | |
| Data | UE specific, | Allocation | Statistically | Known in |
| Payload | irregular, & long | dependent, | independent | monostatic |
| | | resource | | case |
| | | block | | |
| | | based | | |

As summarized in Table 3, the gap analysis on the existing signals shows that none of these signals ensure the time/frequency pattern/span/periodicity for sensing UC/KPIs. However, the correlation aspects and handling the orthogonality may be the most reusable design aspect from the existing signals. On the other hand, a PRS was defined in NR Rel-16 for UE localization/positioning. As will be discussed in the next section, in terms of the frequency and time resource allocation and patterns/regularities, a PRS is closer to what is desired for sensing compared to other reference/data signals.

### PRS Signal Design and Attributes

PRS is a DL reference signal (RS), introduced in Rel-16, to be measured at the UE side and enable a determination of the position of the UE. The existing DL RSs, like CSI-RS and SSBs, had the following limitations for positioning estimation:

These RSs are not capable of detecting a sufficient number of neighboring gNBs due to interference from adjacent cells when signals from multiple cells collide in both the time and frequency domains. Due to this interference, signals from nearby cells shadow weak signals from far away cells, causing difficulty for UE to detect far away cells or gNBs. This difficulty results in a loss in hearability.

These RSs also have weak correlation properties due to low RE density, and the RE pattern of the RSs might not spread across all SCs in FD. Some of PRS configurations are identical to tracking reference signals (TRS). This allows TRS to be reused for positioning purposes, which can be useful as a way to reduce overhead, albeit with a reduced performance compared to an unrestricted PRS configuration.

To overcome these limitations, 3GPP introduced PRS in NR Release 16. PRS hearability is achieved with a concept called muting. With PRS muting, multiple cells transmit PRS in a coordinated manner by muting relevant PRS transmission occasions to avoid interference from adjacent cells. On the other hand, with a high RE density and with correlation properties better than that of existing RSs (due to diagonal or staggered PRS RE pattern). Although other signals can be used for positioning, PRS is specifically designed to deliver the highest possible levels of accuracy, coverage, and interference avoidance and suppression. 3GPP has standardized power, angular and time measurement support for the PRS.

To design an efficient PRS, special care was taken to give the signal a large delay spread range, since it must be received from potentially distant neighboring BSs for position estimation. This is achieved by covering the entire NR BW and transmitting the PRS over multiple symbols that can be aggregated to accumulate power.

PRS signal is a quadrature phase-shift keying (QPSK)-modulated OFDM signal, where a sequence for QPSK modulation is derived from a NR Gold sequence generator. The generated sequence is then mapped to the physical resources according to a certain structure.

NR uses a hierarchy to define the DL PRS signal resource structure, which includes the positioning frequency layers, PRS resource sets, and PRS resources. This allows the network to provide assistance data in a structured format, and also enables the UE to locate resources unambiguously to perform measurements. A frequency layer includes one or more PRS resource sets across one or more sites/TRP, all with the same carrier frequency, numerology, reference point, and configured PRS BW. Frequency layers enable configuring carrier aggregation for the fusion of measurements over multiple carriers. A PRS resource set contains PRS resources from same TRP. A DL PRS resource set includes multiple DL PRS resources associated with different beams (transmission directions). A PRS is transmitted using one PRS resource and the UE performs positioning-related measurements using this RS. Each PRS resource can occupy 2 to 12 symbols within a slot depending on the configuration and typically corresponds to a beam from that TRP. The structure where different PRS resources (with different IDs) are used in different beams can be used to estimate the angle of arrival (AoA) relative to the UE. A DL-PRS measurement (e.g., Reference Signal Time Difference (RSTD), UE Rx-Tx Time Difference Measurement, Reference Signal Received Power (RSRP)) is made per DL-PRS Resource. By configuring the UE to measure on a certain PRS resource in a PRS resource set, the Location Management Function (LMF) learns about the TRP corresponding to the PRS resource set, and the particular beam from that TRP.

The DL PRS signal supports configurable numerology, i.e., a SCS of 15, 30, 60, 120 kHz with CP length normal vs extended, for 60 KHz.

The PRS supports configurable allocation in time and frequency, in addition to the periodic allocation in the time domain. Particularly, PRS supports time domain repetition of beams at an intra-PRS-resource level and at an intra-PRS-resource-set level, with different patterns (to support different beamforming options, as well as flexible support of repetition and processing gain). PRS resource set (and hence, all its PRS resources) also have a periodic pattern, with periodicity depending on the SCS.

Particularly, there are two levels of repetition related to DL-PRS. The first one is “intra-slot level repetition”, where DL-PRS symbols are repeated multiple times within same PRS resource, e.g., a comb-2 DL-PRS resource may span more than two symbols. The number of symbols per DL-PRS resource within a slot is the same for all resources in a DL-PRS resource set. The other level of repetition is defined by “DL-PRS resource repetition”, where each DL-PRS Resource is repeated and transmitted with the same DL spatial domain transmission filter (i.e., same beam) across multiple slots. Each repetition instance of a DL-PRS resource can only occur in one slot; i.e., a slot cannot carry the repetition instances of the same DL-PRS resource (that would have been intra-slot level repetition).

In the frequency domain, the PRS resource can be configured to span over different bandwidths, up to the entire system bandwidth (5-100 MHz in FR1 and up to 400 MHz in FR2), with a [permuted staggered] comb structure for the REs usage within the bandwidth. The comb structure as specified in NR, determines RE usage both in the frequency domain and over the time domain OFDM symbols. As such, multiple time-frequency RE patterns are supported via various staggered comb patterns. The comb size and the number of symbols involved in the comb pattern form a trade-off between the measurement latency, avoiding ambiguity/aliasing in the correlation function, power boosting (since not all subcarriers are occupied with a comb-N signal with N>1, more transmit power is available per RE), frequency reuse, degree of frequency domain orthogonality supported between different cells, and the coherent integration duration. From basic Fourier transform properties, a comb-N frequency domain signal produces time domain equivalents with N repetitions (“aliasing”). OFDM communication systems are robust against such ambiguities as long as channel delay spread is less than the ambiguity distance. However, such ambiguities are detrimental to positioning systems that depend on measurements of ToAs, since ambiguities may produce false peaks in the correlation function that can lead to wrong position estimates. After coherent combining (integration) of the two staggered comb-2 DL-PRS symbols, an equivalent comb-1 pattern is obtained without alias peaks in the correlation function (“de-staggering”).

Even though it is not mandated by the specification, for good performance, no other DL signal transmission is expected on the PRS resources, effectively resulting in a dedicated DL PRS resource grid.

### PRS Flexibility for Beamforming and Spatial Allocation

Flexible spatial allocations are also enabled within a PRS resource set. In particular, there can be different resources (beams) within a set, as a PRS resource set contains PRS resources from the same TRP. The current PRS design enables the possibility to repeat some directions more than others. Even though all resources repeat by the same number within a resource set but within a resource, for comb-2, 1 or 2 or 3 or 6 repetitions can take place, which provides more flexibility. Further, both a sweep-before-repeat and repeat-before-sweep strategy is supported. In the context of sensing, sweep-before-repeat can be beneficial for use cases with lower speed detection limitations, where SRI durations of multiple slots are adequate. On the other hand, for use cases with more demanding Doppler estimations and shorter SRI durations, repeat-before-sweep is more applicable.

In the supported PRS hierarchy, a TRP may have up to two PRS resource sets per frequency layer to allow for different beamforming across the different sets. For instance, a gNB can configure a set of narrow beams to cover a region that is mapped to one set, and another set of wider beams to target a slightly different coverage that can be mapped to the second resource set. As such, even at the higher level than the resource set, some flexibility in terms of the beamforming and spatial coverage is supported. In the context of sensing, this design aspect may also have application in realizing sub-slot-level SRI durations, as described below. Further, this concept may be reused to define multiple sensing frames (together with their corresponding SRI settings) for a sensing gNB (to benefit from different measurements).

### Parameters Describing the DL-PRS Resource

The following is the list of parameters to be configured for a PRS resource:

A DL-PRS Resource ID, defining a particular DL-PRS Resource. A DL-PRS Resource ID in a DL-PRS Resource Set is associated with a single spatial TX filter (beam) and is transmitted from a single TRP.

A DL-PRS Sequence Identity, defining an initialization seed for the pseudorandom Gold sequence generator for the DL-PRS Resource.

A DL-PRS Comb Size N, defining RE spacing in the frequency domain for each symbol of the DL-PRS Resource. N can take the values {2, 4, 6, 12}.

A DL-PRS RE Offset, defining RE offset in the frequency domain for a 1^{st} symbol in the DL-PRS Resource. Relative RE offsets of following symbols are defined relative to RE offset of the 1^{st} symbol in the DL-PRS Resource.

A DL-PRS-Resource Slot Offset, defining the starting slot of the DL-PRS Resource with respect to the corresponding DL-PRS-Resource Set Slot Offset.

ADL-PRS Resource Symbol Offset with values {0, 1, 2, . . . , 12}, defining the starting symbol of the DL-PRS Resource within a slot determined by the DL-PRS Resource Slot Offset.

A DL-PRSNumber of Symbols, defining the number of symbols per DL-PRS Resource within a slot. Values of {2, 4, 6, 12} are defined. Each PRS resource is configured with one beam, and it is not possible to have one symbol in one PRS resource with one beam and another symbol with another beam.

A DL-PRS Subcarrier Spacing, defining the Subcarrier Spacing for the DL-PRS Resource (15, 30, 60 kHz for FR1; and 60, 120 kHz for FR2).

A DL-PRS Cyclic Prefix, defining the CP length of the DL-PRS Resource (normal or extended).

A DL-PRS Point A, defining the absolute frequency of the reference resource block for the DL-PRS. Its lowest subcarrier is named “DL-PRS Point A”.

A DL-PRS-Start PRB, defining the start PRB index as an offset from DL-PRS Point A, in multiples of 1 PRB.

A DL-PRS Resource BW, defining the #PRBs allocated for the DL-PRS Resource (allocated DL-PRS bandwidth) in multiples of 4 PRBs.

A DL-PRS Quasi-Colocation Information, providing quasi co-location (QCL) information between the DL-PRS and other reference signals.

### Parameters Describing DL-PRS Resource Set

The following is the list of parameters to be configured for a PRS resource set:

A DL-PRSResource Set Identity, which defines an identity of the DL-PRS resource set configuration.

A DL-PRSPeriodicity, which defines the DL-PRS Resource's (more accurately, resource set's) periodicity in the number of slots. Periodicity depends on the SCS and can take values of 2^{μ}{4, 5, 8, 10, 16, 20, 32, 40, 64, 80, 160, 320, 640, 1280, 2560, 5120, 10,240} slots, with μ=0, 1, 2, 3 for SCS 15, 30, 60 and 120 kHz, respectively. All the DL-PRS Resources within one resource set have the same periodicity.

A DL-PRS Resource Repetition Factor, which defines how many times each DL PRS Resource is repeated for a single instance of the DL-PRS Resource Set. Values of {1, 2, 4, 6, 8, 16, 32} are supported. All DL-PRS resources within one resource set have the same Resource Repetition Factor.

A DL-PRSResource Time Gap, which defines the offset in #slots between two repeated instances of a DL-PRS Resource with the same DL-PRS Resource ID within a single instance of the DL-PRS Resource Set. Values of {1,2, 4, 8, 16, 32} are supported.

A DL-PRS Muting Pattern, which defines a bit map of the time locations where the DL-PRS resource is transmitted or not for a DL-PRS Resource Set. The bit map size can be {2, 4, 8, 16, 32} bits long.

A DL-PRS Muting-Bit Repetition Factor, which defines the number of consecutive instances of a DL-PRS Resource Set corresponding to a single bit of the DL-PRSMuting Pattern for Option 1 muting.

A DL-PRS Resource Set Slot Offset, which defines the slot offset with respect to SFN #0/slot #0 of the TRP, i.e., defines the slot where the first DL-PRS Resource of the DL-PRS Resource Set occurs.

The DL-PRS Resource list, defining the configuration for each resource in the set, as described above.

### Enabling Reuse of PRS Signal for Sensing

Some embodiments may be directed to assessing feasibility of reusing of a PRS signal for the sensing (even though the possibility may be limited to certain UCs/KPIs). As mentioned earlier, in terms of the frequency and time resource allocation, patterns, and regularities, a PRS is closer to what is desired for sensing compared to other reference/data signals. Particularly, a PRS has higher density and regularity, and the supported patterns are in more synergy with sensing signal attributes. Further, it may be possible to reuse certain PRS configurations for sensing. For example, as described herein, PRS-based sensing may be feasible for UCs with more limited FoVs, or UCs that do not demand extremely high Doppler estimation.

Apart from the resource attributes and signal resource structure, there are also other design aspects, e.g., interference handling, muting, sequence generation and initialization, CA, etc., for which similar concepts/methods may be also applicable/expandable to sensing.

PRS Signal Resource Structure from the Sensing Point of View

In order to understand feasibility of reusing a PRS signal for sensing, it is useful to identify the analogies and differences between the specified PRS signal, and the desired resource structure for the sensing signal (as discussed in the earlier sections).

Example 1: mapping PRS attributes to sensing signal desired attributes—Analogies and differences between PRS and sensing signal attributes.
1) The frequency layer may be relevant for the CA setting for sensing.
2) Resource set++sensing block: possible durations for the PRS resource set are based on repetition parameters and the number of resources within the set, e.g., may be from one slot (if repetition factor is 1—less desired for sensing) to multiple slots.
3) The number of PRS resources within a PRS resource set ↔ the number of beam directions in the SRI: this also determines the time gap for the repetition to support multiple direction in SRI and is also related to the number of OFDM symbols [symbol pairs—since the minimum duration of a PRS resource is 2 OFDM symbols] within the SRI. Each PRS resource is mainly dedicated to one direction, as each PRS resource corresponds to a beam from one TRP. For sensing, a comb-2 structure is mainly preferred because, compared to the larger size combs, it provides more intra-SRI flexibility of assigning OFDM symbols to different directions and/or for different purposes (PRS vs non-PRS), while also imposing fewer limitations on the maximum unambiguously detectable range.
4) SRI ↔ collection of one occurrence of all PRS resources within the set. For sensing, each symbol within the SRI can be allocated to a different beam/direction. Also, in a PRS resource set, multiple PRS resources are transmitted, each for one direction. Beside the intra-set repetition factors, for comb-2, up to 6 repetitions may be within one PRS resource. This is equivalent to using multiple SRI symbols for repetition of the same direction and processing gain. Across SRIs within a sensing block, the pattern of resources and directions should be the same (additional processing is used for irregular resources, which may not be always justified). As such, a consistent configuration of PRS resources in PRS resource sets is desirable.
5) Repetition factor for PRS resource repetition within one instance of resource set ↔ Doppler FFT size, k.
6) Periodicity of resource set ↔ update rate for sensing.

Parameters 2-6 regarding the DL-PRS resource set configuration (discussed in a previous section), together with parameters 3, 6, and 7 regarding DL-PRS resource configuration, can determine the time domain pattern for the PRS. As such, also considering the derived analogies, with a certain configuration of the PRS resources and PRS resource set, e.g., time gap and the repetition factor, the repetitive pattern would be more in synergy with the sensing case.

### Example 2: One-Direction Sensing Via PRS

For one-direction sensing, one PRS resource, i.e., one beam direction, and repetitions of that resource for Doppler estimation is used. For PRS-based sensing, it is useful to understand that with proper PRS configurations, how frequent occurrence of one direction can be for Doppler processing and with what granularity time/frequency resources for that direction can be configured.

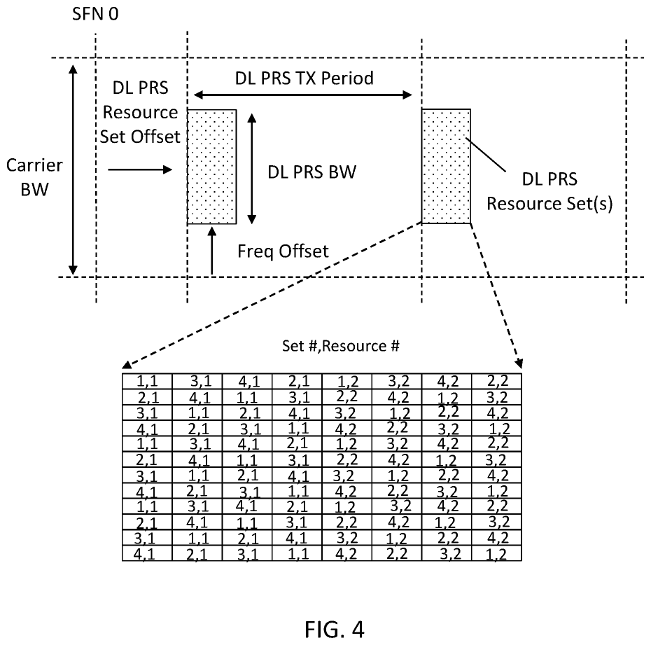

A look into slot-level supported patterns of PRS resources, shows that within a slot, there can exist one or multiple PRS resources (of one or multiple resource sets), each with or without intra-slot-level repetition. FIG. 4 illustrates a NR PRS resources configuration in accordance with some embodiments. For example, it is possible that multiple PRS resources, e.g., each of length 2 OS, are Time-Domain-Multiplexed within one resource set of length one slot. The parameter L-PRS Resource Symbol Offset controls the starting symbol of each DL-PRS Resource in a slot.

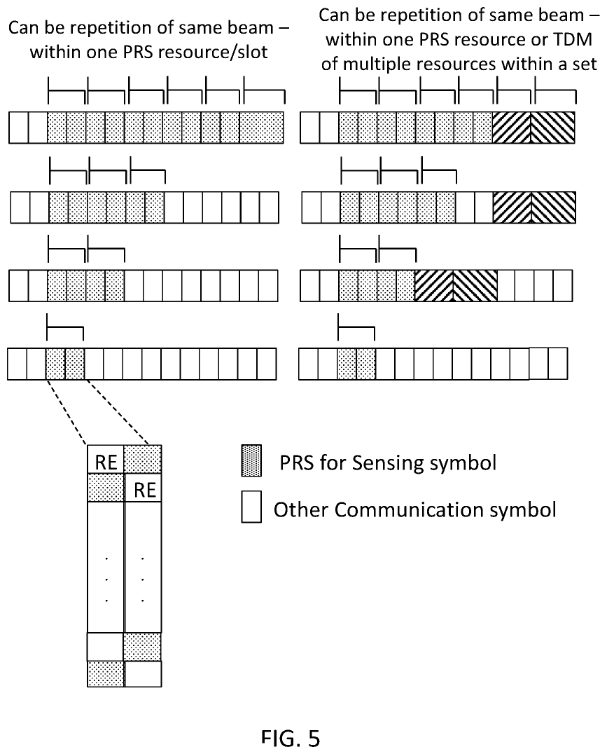

While repetition of the PRS resources occurs across slots, repetition of a beam is also allowed within the resource, which may be mainly used for processing gain (not Doppler estimation). In particular, based on the analogies built in the previous section, intra-slot repetition can allow for repetition of a particular beam within the SRI for power gain, and may not help with speed detection. For example, at most 6 repetitions of a comb-2 is supported within one slot. FIG. 5 illustrates PRS repurposing for sensing in accordance with some embodiments.

As discussed in prior sections, SRIs of length 7 Over-Sample (OS) or 140S or 280S would be used (at least for traffic monitoring UCs which does not require extremely high speeds). With PRS-based sensing, SRI durations of integer numbers of slots can be achieved straightforwardly, since the repetition pattern and time gaps are defined with a slot granularity. However, for half-slot SRI durations, the current PRS resource settings may have some limitations, as will be discussed.

Regarding SRI durations of integer slot multiples (minimum of one-slot SRI duration), depending on the time gap being set for the PRS repetition, different SRI durations can be defined. For example, with a repetition time gap of 1 slot and all PRS resources of the set also packed next to each other within a slot, e.g., each PRS resource is 2-12 OFDM symbols, an SRI duration of one slot can be achieved. With a time gap of 2 slots and all PRS resources of the set are also packed next to each other within a slot, an SRI of 2 slots can be achieved in which the sensing transmission takes place only within the first slot of the SRI. The same logic applies for larger time gaps, leading to lower Doppler/speed detection. Essentially, the resulting PRS resource set duration, i.e., equivalent of sensing frame duration, would be equal to (repetition factor)×(time gap).

In NR PRS design, in each slot, (at least) two symbols are not used for PRS transmission and are reserved for other communication channels (PDCCH, PDSCH, etc.). For sub-slot level SRI duration, the non-PRS symbols should be properly handled and minimum gap within the PRS slot dealt with. Otherwise, sub-slot level SRI used for sensing can cause irregularities across SRIs, which is undesirable (since inconsistencies across SRIs troubles the repetition and Doppler FFT processing). For example, the same number and allocation of OFDM symbols across all (sub-slot-level) SRIs should be considered for non-PRS transmissions to realize a sub-slot-level SRI. Since each PRS resource occupies an even integer number of OFDM symbols, and a half slot in NR consists of 7 OFDM symbols, for non-PRS transmissions the simplest way with the current PRS design would be to accommodate 3 OFDM symbols within the first half and same 3 OFDM symbols in the second half of the slot. It is noted that each half slot forms an SRI over different PRS resource sets, each consisting of 4 OFDM symbols, covering one or two PRS resources, in addition to the 3 OFDM symbols used for other purposes. The two PRS resources sets each in a half-slot should be configured with similar pattern and number of PRS resources, covering same spatial domains to maintain the consistency across SRIs.

For example, the durations are either 2, 4, 6, or 12 ‘consecutive’ symbols for a PRS resource of comb-2. It is not possible to have two symbols of a 4-OS comb2 PRS resource in the first half of the slot and the other two symbols in the second half. These limitations are to be to take into consideration and be dealt with properly.

For more flexibility in terms of reusing PRS design for sensing, some expansion and enhancements are proposed in a following subsection.

### Example 3: Multi-Direction Sensing Via PRS

Multiple PRS resources, i.e., multiple beam directions, and repetitions of those resource for Doppler estimation is used for multi-directional sensing. Within the resource, repetition of each beam is mainly for processing gain within the SRI, not for Doppler estimation.

The SRI can be defined differently depending on how different resources of a single or multiple resource sets are located. Even though a sub-slot-level SRI may be also made possible with PRS, as discussed in the previous section, the structure of PRS allows for a limited number of directions to be covered within one SRI. For example, the same number and allocation of OFDM symbols across all (sub-slot-level) SRIs should be considered for non-PRS transmissions to realize a sub-slot-level SRI. Again, as in the previous example, each PRS resource occupies an even integer number of OFDM symbols, and a half slot in NR consists of 7 OFDM symbols, so the simplest way with the current PRS design for non-PRS transmissions would be to accommodate 3 OFDM symbols within the first half and the same 3 OFDM symbols in the second half of the slot. Each half slot forms an SRI using a different PRS resource set, consisting of 4 sensing OFDM symbols, covering one or two PRS resources (one or two beam directions) and 3 non-sensing OFDM symbols. This may be achieving limited FoV coverage or processing gain. Embodiment for more flexibility in terms of FoV coverage within the SRI, and/or higher processing gains are discussed below.

For SRI durations of integer multiples of slots, similar to the one-directional sensing case, if multiple PRS resources of the same resource set are TDMed within one slot (e.g., up to 6 comb-2 resources can fit within one slot), and if all resources of a set fit in a slot, the minimum SRI duration of one slot would be achieved. Depending also on the time gap set for the repetition, different SRI durations can be defined.

Further, if a PRS resource set contains resources over multiple slots, either one slot per resource, or mix of slots with single and multiple resources, SRIs over multiple slots can be also defined, effectively for lower Doppler estimations.

### Expansions, and Adaptations to PRS for Reuse in Sensing

Based on the discussions provided in prior sections and the similarities between desired properties of sensing signal and the supported patterns and structure of PRS signal, if a new sensing signal is defined in the next generation of cellular systems, it likely can be also used for positioning, especially if the design accommodates backward compatibility. From the resource efficiency and overhead perspective, it may not be desired to have both the positioning signal and sensing signal being transmitted in the system (at least at the same time) as much as possible. On the other hand, as previously discussed, motivated by the same reason, it is also logical to adapt the positioning reference signal to accommodate sensing as much as possible.

By enabling PRS-based sensing, the JCAS system can support both BS-based monostatic sensing and UE-based bi-static sensing (BS being the PRS signal transmitter, and UE being PRS signal sensing receiver), as well as UE-based positioning.

In order to enable or enhance the reuse of PRS signal for the purpose of sensing, some accommodations and adaptation seem desired (even for reusing certain PRS configurations just for limited sensing UCs). In the following some such adaptations are disclosed.

Enabling UE's Speed and/or Direction Related Measurements To Allow Velocity Estimation in Localization/Positioning

While a UE's speed estimation by the LMF (or UE) is not currently precluded, the PRS signal is not originally designed to support proper velocity estimation. With the adaptations to the PRS signal herein, it is also possible to perform/report [more accurate] UE's Doppler-related measurements and allow the network and/or UE to perform Doppler-related measurements and direction of movement estimation with better accuracy. For example, currently as part of performing positioning measurements (e.g., ToA, etc.), a correlation function may be applied in delay (range) domain and the peaks in the correlation function can lead to the position estimates. The correlation function may be extended to also have a second dimension in the Doppler domain to enable Doppler processing. This can be similar to generating the 2D periodogram that is part of the baseline object detection receiver processing for sensing applications.

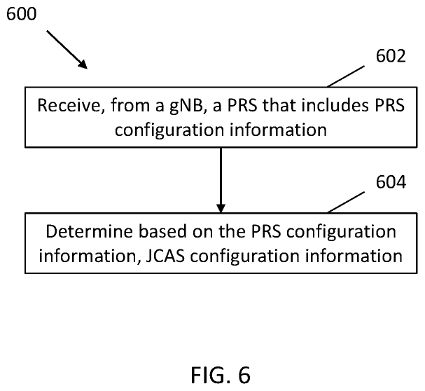

FIG. 6 illustrates a process of determining JCAS configuration information in accordance with some embodiments. In some embodiments, the electronic device(s), network(s), system(s), chip(s) or component(s), or portions or implementations thereof, of FIGS. 1A-5, or some other figure herein, may be configured to perform one or more processes, techniques, or methods as described herein, or portions thereof. One such process 600 is depicted in FIG. 6. For example, the process may include, at operation 602, receiving, from a gNB, a PRS that includes PRS configuration information. The process further includes, at operation 604, determining, based on the PRS configuration information, JCAS configuration information comprising numerology, frame structure, or signal resource dimensioning information.

As above, JCAS presents several unique challenges and design considerations. A flexible design that can operate under different communication and sensing performance and hardware/complexity tradeoffs may be desirable for the coexistence of communication and sensing operations. Sensing signal resource attributes and structure, as well as resource multiplexing between sensing and communication services, are aspects that may be addressed in various embodiments.

Some embodiments may include reusing a PRS signal for sensing purposes, which may be suitably adapted based on analogies and differences between the resource attributes of the NR PRS signal, as well as the desired resource structure for the sensing signal. Further, various embodiments may incorporate expansion and enhancements of NR PRS signal design to enable and/or improve sensing functionality/performance.

Apart from the sensing signal resource and multiplexing aspects, sensing signal generation (e.g., sequence-based signal generation and initialization) is another JCAS system design element. Accordingly, aspects of the generation and initialization of the sensing signal are described below (considering both cases of a PRS-based sensing signal or newly defined sensing signal).

### Potential Sensing Frameworks/Architectures in Cellular Systems

As above, depending on various sensing applications, use cases, and capabilities, JCAS operations can be BS-based, UE-based, or based on both BS and UE. By enabling PRS-based sensing, a JCAS system can support both BS-based monostatic sensing and UE-based bi-static sensing (BS being the PRS signal transmitter, and UE being PRS signal sensing receiver), as well as UE-based positioning.

### Overview of Sensing Signal Frame Structure

As above, SCS denotes the Sub-Carrier Spacing, K is the slow (Doppler) FFT size, OS denotes the OFDM Symbol, and SRI is the Symbol Repetition Interval. The following SRI values and Doppler FFT sizes support highest possible capabilities for velocity estimation under different limitations, and to meet finer velocity resolutions, while keeping the design as simple as possible (without compromising supported sensing performance). In particular:

For all carrier frequencies in FR1, following SRI and Doppler FFT sizes (K) to be supported: For SCS=15 KHz, {SRI, K}={7OS, 32}, {7OS, 64}; For SCS=30 KHz, {SRI, K}={14OS, 32}, {14OS, 64}, {7OS, 64}, {7OS, 128}; For SCS=60 KHz, {SRI, K}={280S, 32}, {280S, 64}, {14OS, 64}, {14OS, 128}. These result in sensing block duration=SRI*k=16, 32 msec.

For FR2, following SRI and Doppler FFT sizes (K) to be supported: For SCS=60 KHz, for all carrier frequencies in FR2, {SRI, K}={7OS, 64}, {7OS, 128}, which results in sensing block duration=SRI*K=8, 16 msec. Further, for frequency<30 GHz in FR2, {SRI, K}={14OS, 32}, {14OS, 64}, {14OS, 128} are also supported, resulting in sensing block duration of 8, 16, 32 msec. For frequency>50 GHz in FR2, {SRI, K}={7, 256} is also supported, resulting in sensing block duration of 32 msec. For SCS=120 KHz, for all carrier frequency in FR2, {SRI, K}={14OS, 64}, {14OS, 128} are supported, resulting in sensing block duration of 8, 16 msec, and {SRI, K}={7OS, 64}, {7OS, 128} are also supported, resulting in sensing block duration of 4, 8 msec. Further, for carrier frequency>50 GHz in FR2, K=256 is also supported, resulting in sensing block duration of 32, 16 msec for SRI=14, 70S, respectively.

The number of OFDM symbols in the SRI should provide a good balance between the maximum detectable speed, the sensing repetition gain, the flexibility/capability to support multiplexing between communication and sensing, the FoV coverage (depending on the desired number of beams and the beamwidth). Further, as can be seen from the values above, the Doppler FFT sizes are generally smaller is FR1, which involves fewer radio frames for sensing and less limitation and unavailability for communication. As above, the PRS configuration may be extended to allow a single-symbol PRS resource to accommodate larger number of symbols or more PRS resources (and directions) within the SRI, for better FoV coverage, and/or better processing gain, as well as more flexibility in terms of multiplexing of communication and sensing symbols.

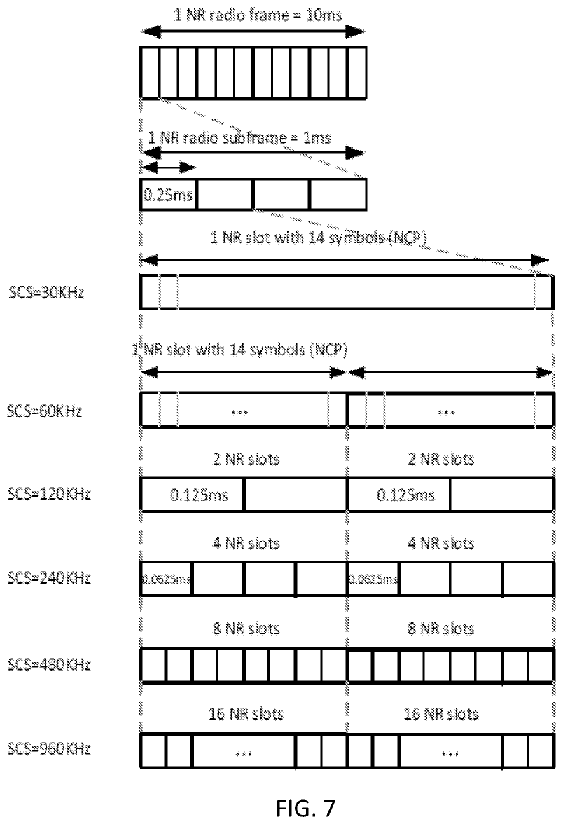

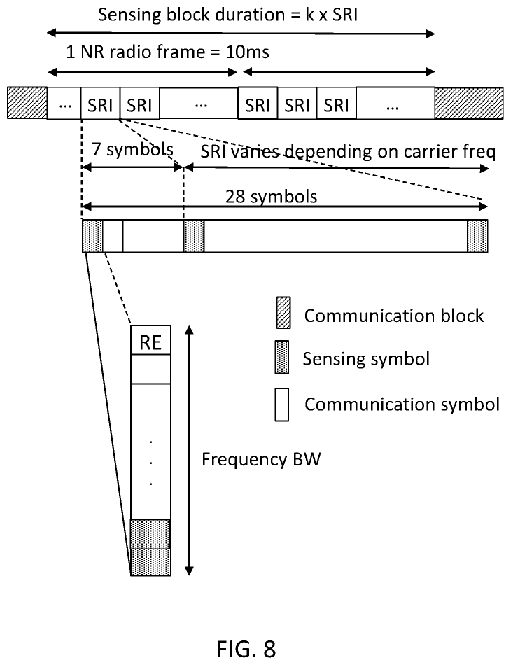

Further, as above, the same CP durations as in NR communication may be employed for OFDM symbols used for sensing. Different CP (and hence symbol duration) between communication and sensing may be employed using the proper alignment between sensing block durations and communication slot boundaries. As also discussed, a communication block can be defined by the overall time interval over which no sensing symbol is taking place. The communication block boundaries are aligned with known time units (symbol, slot, subframe, or frame as defined in NR). This is shown in FIG. 7, which illustrates NR numerologies and frame structure in accordance with some embodiments. Similarly, a sensing block is defined by the time interval within which at least some symbols are used for sensing with a predetermined pattern (e.g., the sensing block may start and end with sensing symbols, and in between, depending on the SRI, etc., some symbols are also dedicated to sensing). This is shown in FIG. 8, which illustrates sensing and communication blocks in accordance with some embodiments. The sensing block boundary may be aligned with the communication block boundary, at some NR-based units.

### Gold Sequence

The Pseudo-Random (PN) Sequence used for signal generation in LTE and NR may be defined by a length-31 Gold sequence. Specifically, a Gold sequence is a PN sequence generated using two different binary m-sequences. A Gold sequence can be generated by logical addition (XOR) of two preferred m-sequences, so it has same period of 2m−1 as for m-sequences and can be implemented by two m-stage linear feedback shift registers (LFSRs). Hence, PN sequences can be generated using m-stage LFSRs. The Gold sequence has an advantage in that different PN sequences can be generated in accordance with a period while varying an initial state of each m-stage LFSR. Gold sequences can provide large number of sequences and the cross-correlation between the sequences are uniformly bounded. The initial seed of the sequence is represented by 31 bits, i.e., the size of initial values may be 31 bits. Hence the total number of the initial seeds is 231.

### Overview of PRS Signal Generation and Initialization

As above, the PRS signal is a QPSK-modulated OFDM signal, where a sequence for QPSK modulation is derived from a NR Gold sequence generator. The generated sequence is then mapped to the physical resources according to a predetermined structure. To map DL-PRS into different REs in one slot with 14 OFDM symbols, each PRS comprises a QPSK modulated PN sequence. The length-31 Gold sequence of the PRS in NR has good correlation properties. The generated reference sequence can be described as:

$$r ( m ) = \frac{1}{√ 2} ( 1 - 2 c ( 2 m ) ) + j \frac{1}{√ 2} ( 1 - 2 c ( 2 m + 1 ) ) .$$

where the initial state of the PN sequence, i.e., c(m) can be formulated as:

$${c}_{init} = ( {2}^{22} ⌊ \frac{{n}_{ID , seq}^{PRS}}{1024} ⌋ + {2}^{10} ( {N}_{symbol}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) {mod2}^{31}$$

Particularly, each generated sequence is initialized/determined by three parameters:

slot number: n_(s,f)^{μ};

DL PRS sequence ID: n_(ID,seq)^{PRS}∈{1, . . . ,4095}—which is one of the parameters describing the DL-PRS resource and is dedicated to defining the initialization seed for the PN Gold sequence generator for the DL-PRS Resource. While there is no specified relationship between n_(ID,seq)^{PRS} and cell ID (unlike LTE, where PRS initialization is based on cell ID), and it is up to each serving cell (each TRP in this case) to flexibly configure the parameter, it may be selected such that the initialization for the sequences generated between different cells are different; and

OFDM symbol index: 1, to which the sequence is mapped.

### Impact of Sequence Initialization on Cross-Correlation and Randomization

Cross-correlation between two generated PN sequences depends on the initial values (“c”_init values) used to generate two PN sequences. Accordingly, proper initialization is to be used for good cross-correlation properties. As such, the parameters in the “c”_init determine the pseudo-orthogonality between the generated sequences. Normally, with different “c”_init values, relatively low cross-correlation between the sequences is expected. Even with one of the parameters determining “c”_init being different between two sequences, the “c”_init value can be different (subject to the effect of the modulo operations), resulting in low cross-correlation. Particularly, as long as the “c”_init is different between two sequences, even if some of the parameters involved in the initialization are the same, low cross-correlation (e.g., pseudo-orthogonality) is expected. The exact level of orthogonality should be evaluated (and also depends on other factors, e.g., length of the sequence, the offset used to segment the original sequence, etc.). Some variations may exist across choices for the changes to the different parameters, and depending on the application of the generated sequence, one of the parameters may appear more significant than others (e.g., n_(ID,seq)PRS in the case of PRS signal). Generally, defining the “c”_init as a function of only one parameter (e.g., slot index, etc.), may not result in a good design. Further, a proper design should maximize uniquity of “c”_init in the 2³¹ bit space resulting from different combinations of parameters values, i.e., a proper design is expected to minimize the chances of multiple parameter combinations resulting in the same “c”_init (after the bit shift, and the mod operation).

The 31-bit “c”_init may accommodate different combinations/formulation of parameters. The manner in which the cross-correlation of the sequences changes with different parameters in the “c”_init involves pairwise evaluation across all different values of the particular parameter. Further, while the cross-correlation property between full-length Gold sequences can be determined and can be shown to be the same for all the different initial value pairs (as long as they are not the same), there is no closed form mathematical formula for partial cross correlation for Gold codes. As the resource allocation size (i.e., the selected (sub-)sequence length to map the allocation) is increased, the Gold sequence becomes sufficiently random not to have very high cross-correlation. In general, it is up to the BS to schedule and configure the sequences properly.

Accordingly, in terms of the involved sequences itself, pseudo-orthogonality exists between sequences mapped to different PRS resources with different n_(ID,seq)^{PRS}, and/or mapped to different slots, and/or mapped to different OFDM symbols, although pseudo-orthogonality may be of less interest when two sequences are mapped to different time resources (which is the case for PRS). Still, different PRS sequences are generated over different symbols and also over different slots (the whole “c”_init repeats every radio frame). However, the sequences are selected not only to achieve lower cross-correlation but also due to their auto-correlation properties and robustness to time-frequency offsets (e.g., as against Zadoff-Chu (ZC) sequences). In the PRS “c”_init, the OFDM symbol index and slot index can provide (inter-cell) interference randomization in case of persistent collisions in time domain, e.g., PRS interfering with another signal/channel—which may provide randomization to the other “victim” signal/channel when the given PRS may be the interferer (“aggressor signal”). Overall, the OFDM symbol index and slot number being a parameter in “c”_init may not impact the cross correlation. These indices may impact the case where there is a collision from other cells and, depending on the OFDM symbol number within the slot and/or the slot number, some such collisions may be avoided (in a synchronized environment, timing is identical between multiple cells, and neighboring cells have the same slot and OFDM symbol number). Alternatively, in future systems such parameters may not be used in the initialization (e.g., as different sequences over slots or symbols are not used), and thus can be removed from “c”_init. In such case, the formula may be adjusted accordingly, i.e., the bit-width of the particular parameter being removed, is reflected inside the “c”_init and the formula shifted accordingly.

On the other hand, if two different sequences are allowed to be mapped to the same time domain resources (which may be a general signal rather than specifically a NR PRS signal), in order to introduce some level of pseudo-orthogonality, it may be desirable not to define “c”_init in terms of the time indices/resources that are shared between the sequences. Still, as mentioned earlier, typically the initialization is not defined as a function of only the time-index. For example, for PRS, the n_(ID,seq)PRS values in the initialization may be playing an even more “fundamental” role compared to the time domain indices. This means that if two sequences are initialized with “c”_(init,1) and “c”_(init,2), respectively, then, if n_(s,f)″ and 1 are the same in “c”_(init,1) and “c”_(init,2), and only n_(ID,seq)PRS is different, then the two sequences still have low cross-correlation (and the cross-correlation is determined by n_(ID,seq)^{PRS} values). For different slot and symbol indices (e.g., with same n_(ID,seq)^{PRS}), the cross-correlation is expected to be low. However, as mentioned above, the sequences for PRS are mapped to different (i.e., orthogonal) time resources, and, as such, a low cross-correlation may be of less concern regarding interference handling. However, a PRS sequence generation and initialization that maintains pseudo-orthogonality helps in terms of the detection performance at the receiver since the UE receiver checks against a particular sequence that the UE is expecting. As such, in terms of the peak detection, pseudo-orthogonality can be beneficial.

On the other hand, from an inter-cell interference perspective, PRS signal transmissions from different cells mainly rely on avoiding transmission on the same resources by means of time domain and/or frequency domain separation as more robust approaches. However, pseudo-orthogonality may still be helpful for inter-cell interference randomization in certain situations, e.g., if an unintended overlap is present from another far-away cell, etc.

In general, sequence-based signal transmission may introduce an additional layer to realize a better level of randomization to improve detectability. Further, in some embodiments, a PRS resource follows a staggered (in time domain) comb (in frequency domain) structure, that at the receiver involves de-staggering and then combining. A sequence-based PRS signal provides a way to realize a longer sequence (by concatenating the different sequences, for de-staggering and combining) and not just repetitions of the same sequence. This may effectively improve both the correlation and the detection performance.

Unlike ZC sequences, the de-staggering benefit from using longer PN sequences is not so much in providing orthogonalization but in estimating the channel against delay spread. To elaborate further, processing gains may be realized by combining after correlating against the shorter sequences corresponding to a N>1 comb design for the different symbols of a PRS resource.

### Sensing Signal Generation

In general, the procedure of sensing signal transmission may include:

The signal sequence is generated, e.g., based on a length-31 Gold sequence. As described above, this generation may be in a similar manner as NR and LTE for hardware efficiency/reuse. After determining initial values of a first LFSR and second LFSR, a portion of the PN sequence generated by the Gold sequence generator is used. Specifically, for a PN sequence having a length of Mmax, a portion of sequence may be used (with length M<=Mmax, where M may vary depending on the number of resource blocks (RBs) used for the transmission.

The generated sequence is modulated into a modulation symbol, e.g., through QPSK modulation.

A portion or the entirety of the reference signal sequence is mapped to the allocated REs.

The reference signal is transmitted in the desired REs.

These operations are applicable to both cases of PRS-based sensing signal or a newly defined sensing signal.

In addition, sensing may also rely on radio signal transmissions, which may not contain modulated symbols generated based on PN sequences (or other types of sequences). For example, sensing may rely on a communication signal (e.g., if at a desired time and direction, a communication signal is available, etc.), which may carry a data payload, or any other signal that may or may not be generated based on mathematical sequences. The focus herein is on cases where sensing is performed based on a particular radio signal transmission for sensing—whether the radio signal is an extension of a PRS signal and the signal can be simultaneously used for positioning purposes as well, or the radio signal is a signal primarily designed for sensing (while it may still be possible to perform positioning using that signal as well).

For MIMO radar, where different transmit antennas in the sensing transmitter transmits orthogonal signals, the orthogonality between signal transmissions can be achieved with non-overlapping resources (e.g., using subcarrier interlacing in frequency domain) or using the orthogonal sequences as described herein.

### Sensing Signal Sequence Initialization for PRS-Based Sensing

Sequence initialization is described for sensing performed based on a PRS signal (or its extensions), as well as for a new signal dedicated for sensing is introduced. For each of these cases, the focus is on what parametrization for sequence initialization may be more beneficial.

In one example, for PRS-based sensing, the PRS resource or PRS resource set configuration allow for different sequence initialization compared to initialization for positioning. For example, while the configuration parameter setting may also include the parameters for PRS signal generation and initialization, other parameters besides (or instead of) the slot number, OFDM symbol index, and DL PRS sequence ID may be also used in the initialization, or one or multiple of these 3 parameters may be removed.

For positioning, different PRS signals within a cell are transmitted over different PRS resources which are mapped to different time domain OFDM symbols (e.g., multiple PRS resources can be time domain multiplexed in a slot). In some embodiments, each PRS resource can be used to carry sensing signal in a given direction. As such, different beams are transmitted over different times. Heuristic evaluations may be used to quantify the actual benefits from initializing sequences that are already mapped to orthogonal time resources and transmitted in different spatial resources (beams) as a function of symbol index, e.g., in terms of further randomization and better sensing detection. However, detection in positioning has similarities to detection for sensing in terms of calculation of a correlation function (ambiguity function) and identifying/detecting the peaks of the function to help with position estimation; for example, for RSTD measurements, the receiver tries to estimate the time of arrival for the particular PRS resource for a particular PRS. As such, it can be beneficial to also allow the signal initialization for sensing to be a function of the symbol index.

Further, different PRS signals across different cells are transmitted over different frequency domain resources for positioning. Time domain separation, e.g., at the slot level, (on top of the frequency domain orthogonality) is also possible via time domain muting. Keeping the initialization as a function of slot number (similar to the case of positioning), may be also beneficial in terms of further randomization and better detection performance. For example, these indices may impact situations in which there is a collision from other cells and, depending on the OFDM symbol number within the slot and/or the slot number, such collisions may be avoided (in a synchronized environment where timing is identical between multiple cells and neighboring cells have same slot and OFDM symbol number).

Having different sequences based on symbol number may also be useful where the sensing receiver receives a long echo (longer than the symbol) for target(s) located far away. Accordingly, ghost targets can be avoided by having orthogonal sequences for different symbols.

Lastly, for positioning, a DL PRS sequence ID is also one of the initialization parameters and may be selected such that the initialization for the sequences generated between different cells are different. The DL PRS sequence ID may play more of a role compared to slot number and OFDM symbol index. A similar role for the DL PRS sequence ID may also be beneficial for sensing.

Thus, the three initialization parameters used in positioning may remain for sensing. In future systems, however, one or more of these parameters may not be used in the initialization (e.g., different sequences based on slot number may not be used, while the use of different sequences in the initialization may not be harmful to the sensing performance), they can be removed from “c”_init. In such case, the formula may be adjusted accordingly, i.e., the bit-width of the particular parameter may be removed, and may be reflected inside the “c”_init, which may be shifted accordingly.

On the other hand, further parametrization may also be allowed for sensing, even if sensing is based on a PRS signal (or its extensions), as discussed below.

Sensing normally relies on SRI uniformity within the sensing block, i.e., sensing symbols (dedicated to beam directions) to maintain the same pattern from one SRI to the next SRI within one sensing block so that the Nyquist rate for Doppler processing is maintained (by proper selection of SRI duration) and Doppler estimation can be achieved by FFT processing. Such uniformity is not disturbed by using potentially different content for the signal mapped to the proper space-time resources (i.e., the resource structure in the time domain is used for Doppler processing and the resource structure in the frequency domain is used for range processing). Particularly, since the sequence content is removed in the demodulation processing, as long as the sequences do not clash (do not correlate), the sensing detection works properly. As such, as long as the receiver knows what signal has been transmitted, and the signal is mapped to the time resources that meet the Doppler conditions, it is possible to perform the Doppler estimation. Thus, sequences being different over different OFDM symbols, slots, SRIs, subframes, or any other time units may be problematic for sensing detection. Further, even if the pattern of the symbols dedicated to sensing within the SRI is different between SRIs within same sensing block, non-FFT correlation-based processing (which can be more elaborate compared to FFT) may still enable the Doppler processing. In summary, as long as the signal is spaced to meet the Nyquist rate (in the time direction for Doppler processing or in frequency direction for range processing) the parameter can be detected unambiguously. In this case, while also having uniform resource pattern makes it easier to process with FFT, a non-uniform resource pattern can still enable the detection.

### Sensing Signal Sequence Initialization, for General Sensing Signal

For positioning, even repetitions within the slot (e.g., when a PRS resource of lcomb-2 size, occupies 4, or 6 or 12 OSs), the initialization, and hence the sequence, is different over different copies. The PRS is generated for each of the 4, 6, 12 symbols—where, due to comb-2 pattern and an associated comb (starting) offset, the pattern for RE mapping repeats every 2 symbols in this example, but not the sequence itself. The reception is then performed based on combining the correlation results in each symbol. Similar cases exist for slot-level repetitions, e.g., repetitions of a DL PRS resource.

In one example, the PN sequence for sensing signal is initialized based on (i.e., “c”_init being a function of) one or more of the following:
Symbol index, and/or slot number, and/or subframe number, and/or radio frame number, and/or SRI number (e.g., within the sensing block), in which the signal is being transmitted;
physical layer cell identity;
CP duration;
Number of SRI in sensing frame; and
Number of OFDM symbols within the SRI (i.e., SRI duration in OS).

In one example, for UE-based sensing scenarios, a device-specific parameter is included in the initialization of the sequence used in signal transmission by the device.

In this case, a sensing ID to be assigned to devices that generate sensing signals in the network. This may result in reduced interference if two BS share the same resources. For bi-static sensing (i.e., Case 3 in the “Potential Sensing Frameworks/Architectures” section above), where the sensing signal is based on PRS or its extension, or a separate sensing signal is adopted, all the devices involved in the sensing may be made aware of the initial settings, sequence parametrization, initializations, etc.

As above, low cross-correlation (i.e., pseudo-orthogonality) is expected as long as the “c”_init is different between two sequences, even if some of the parameters involved in the initialization are the same. For UE-based sensing (e.g., where UEs transmit the sensing signal), pseudo-orthogonality between generated sequences can be leveraged to avoid or reduce interference between the sensing signals from multiple devices in the network (e.g., even corresponding to BSs of different cells). Even when the sensing resources are the same or overlapping for sensing signals across the entire network, pseudo-orthogonality across the generated sequence may be used for signal separation. Sharing resources for sensing across different sensing nodes may be even deliberately done because the interference with described signal generation method can be carefully controlled.

### Improving Randomization Via Initialization Adaptations

As discussed in the “Impact of Sequence Initialization on Cross-Correlation and Randomization” section above, initial values used in generation of a basic sequence can be changed to improve cross-correlation. In one example, initial values may vary differently according to changes in the subframe number, slot number, and/or the OFDM symbol number between cells. For one cell, the initial value may be increased or decreased as the OFDM symbol number is increased, while in another cell, the reverse may be true.

In one example, the OFDM symbol number may be extended in a radio frame unit (or in a sensing block unit) instead of existing within a subframe or a slot, so that changes of initialization are different as the OFDM symbol number varies (e.g., to allow each OFDM symbol to have a unique OFDM symbol number in one radio frame, or in one sensing block, etc.).

For a length-31 Gold sequence, the size of initial values is 31 bits. Allocation of the bits in the bitwidth to different initialization parameters also affects cross-correlation. PN code initialization may be modified in terms of the number of bits of the length-31 Gold sequence to accommodate different parameters used for initialization.

The periodicity of the signal itself may also be extended by introducing initialization parameters with large periodicities. This extension of periodicity may mean that if two signals/sequences correlate in one occasion, the conflict may not be repeated in each/every instance of transmission. For example, if the time-varying variables do not change from radio frame to radio frame in a transmission, then the PN may not have a periodicity greater than 10 ms. Therefore, sensing signal transmissions may be substantially similar from radio frame to radio frame. An additional initialization parameter, with other periodicities, may be added to the PN sequence initialization. This may resolve conflicts in some circumstances, e.g., if the signals have high cross-correlation over certain occurrences, this may not repeat for all other occurrences.

### Improving Randomization Via Offset Adaptations

In the initial values of the Gold sequence generator, if only a single parameter (e.g., cell ID) differs and other values (e.g., a subframe number and an OFDM symbol number) are identical, a generated pseudo-random sequence may equally overlap in some periods. This occurs because only values of a limited number of bits of the initial values are different among 31 bits of the initial values. This problem may be addressed by considering a fact that usually, only a portion of a sequence generated as a reference signal is used for the signal, depending on the number of REs (subcarriers) to be mapped to. This means that even if a pseudo-random sequence having a length of Mmax (basic sequence) is generated, a sequence having a length of M<=Mmax (used sequence) is used according to the number of allocated RBs. Thus, if the used sequence is selected at different offsets from basic sequences generated (e.g., according to the cell ID, etc.), it may be possible to address the problem that the sequence overlaps in portion due to almost identical initial values. In particular, if the used sequence is selected at different offsets from the basic sequence, it is possible to introduce further randomization in the sensing signal and thereby avoid overlapping of generated PN sequences in some parts due to similarities in initial values. That is, an offset of used sequence, e.g., a start point of used sequences can be set differently as a function of one or more of:

Symbol index, and/or slot number, and/or subframe number, and/or radio frame number, and/or SRI number (e.g., within the sensing block), in which the signal is being transmitted;
physical layer cell identity;
CP duration;
Number of SRI in sensing frame; or

Number of OFDM symbols within SRI (i.e., SRI duration in OS)), so that the used sequences may vary even if initial values are similar. Hence, randomness may be at least increased.

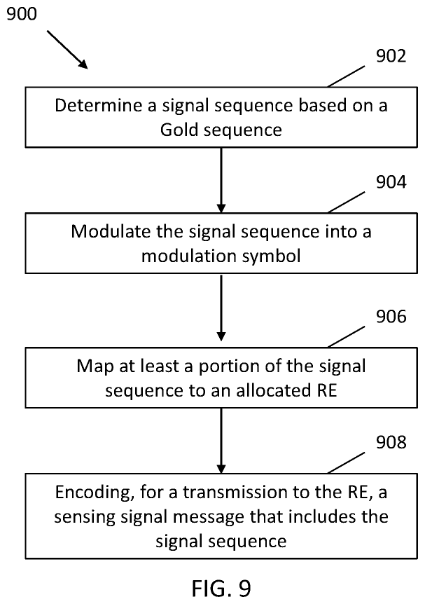

FIG. 9 illustrates a process of providing a sensing signal message in accordance with some embodiments. In some embodiments, the electronic device(s), network(s), system(s), chip(s) or component(s), or portions or implementations thereof, of Figures YX-ZZX, or some other figure herein, may be configured to perform one or more processes, techniques, or methods as described herein, or portions thereof. One such process is depicted in FIG. 9. For example, the process 900 may include, at operation 902, determining a signal sequence based on a Gold sequence. The process further includes, at operation 904, modulating the signal sequence into a modulation symbol. The process further includes, at operation 906, mapping at least a portion of the signal sequence to an allocated RE. The process further includes, at operation 908, encoding, for transmission to the allocated RE, a sensing signal message that includes the signal sequence.

Any of the various embodiments described herein may be employed to perform sensing to obtain measurements that may be useful to estimate features such as range, velocity, and motion of objects in an area of interest (environment). Measurements obtained with such sensing may be used to enable applications such as presence detection and gesture classification, in addition to others such as those for NG-related applications.

### Examples

Example 1 is an apparatus of a sensing device in a next generation (NG) network, the apparatus comprising: processing circuitry to configure the sensing device to: map modulated symbols to time and frequency resources of an Orthogonal Frequency Division Multiplexing (OFDM) resource grid such that a total time span over which recurring OFDM symbols are occupied by the modulated symbols is a multiple integer (k) of a periodicity with which the modulated symbols are mapped to OFDM symbols (T_{SRI}, where SRI is a Symbol Repetition Interval), limits of T_{SRI} are dependent on a subcarrier spacing (SCS) of the OFDM resource grid, inter-carrier interference (ICI), a carrier frequency (f_{c}), a maximum detectable velocity (vₘₐₓ), and a speed of light (c₀), and limits of k are dependent on bandwidth (BW), T_{SRI}, resolution with which a velocity is detected (Δv), the carrier frequency, and the speed of light; and transmit the modulated symbols, mapped to the OFDM resource grid, using a single spatial precoding; and memory configured to store the modulated symbols.

In Example 2, the subject matter of Example 1 includes, wherein: T_{SRI} satisfies

$$\frac{m}{2 \times SCS} \leq {T}_{SRI} and {T}_{SRI} \leq \frac{{c}_{0}}{4 {f}_{c} {v}_{max}} ,$$

where m is selected to maintain a predetermined inter-carrier interference (ICI), and k satisfies:

$$\frac{{c}_{0}}{2 {f}_{c} Δ v \times {T}_{SRI}} \leq k \leq \frac{2 {f}_{c}}{BW} .$$

In Example 3, the subject matter of Example 2 includes, wherein the processing circuitry configures the sensing device to: map the modulated symbols to the OFDM resource grid such that dimensioning of a cyclic prefix duration (Tₒp) in the OFDM symbols for the SCS is not to achieve ISI-free detection for a maximum desired distance, a non-ideal performance is tolerated up to a distance n×c₀T_{cp}/2, where n is selected such that objects at distance d are detectable without aliasing, and d meets: d_{max, no-ISI}≤C₀T_{cp}/2≤d≤n×c₀T_{cp}/2≤d_{max, unambig}=c₀/(2×SCS), and support Top for SCS>60 KHz, configurable from a set of plurality of predetermined values.

In Example 4, the subject matter of Example 3 includes, wherein the processing circuitry configures the sensing device to: select n dependent on a sensing environment; and map the modulated symbols to the OFDM resource grid such that tanhe effective spacing between subcarriers used for mapping of the modulated symbols within a total frequency span over which recurring subcarriers are occupied by the modulated symbols, is based on a largest integer value m_{comb} for which n×c₀T_{cp}/2≤c₀/m_{comb}(2×SCS) is derived, and the modulated symbols are mapped to every m_{comb}-th subcarrier.

In Example 5, the subject matter of Examples 1-4 includes, wherein: T_{SRI} is 7, 14, or 28 OFDM symbols (OS), dependent on the maximum velocity, for carrier frequencies in Frequency Range 1 (FR1), supported SRI durations include:for SCS=15 KHz, {T_{SRI}, k}={7OS, 32} or {7OS, 64}, for SCS=30 KHz, {T_{SRI}, k}={14OS, 32}, {14OS, 64}, {7OS, 64}, or {7OS, 128}, and for SCS=60 KHz, {T_{SRI}, k}={280S, 32}, {280S, 64}, {14OS, 64}, of {14OS, 128},which result in a sensing block duration=k×T_{SRI}=16 or 32 msec, and for carrier frequencies in FR2, supported SRI durations include: for SCS=60 KHz, {T_{SRI}, k}={7OS, 64} or {7OS, 128}, which result in a sensing block duration=8 or 16 msec, for carrier frequencies<30 GHz, {T_{SRI}, k}={14OS, 32}, {14OS, 64}, or {14OS, 128}, resulting in a sensing block duration=8, 16, or 32 msec, and for carrier frequencies>50 GHz, {T_{SRI}, k}={7, 256}, resulting in a sensing block duration=32 msec, for SCS=120 KHz, {T_{SRI}, k}={14OS, 64} or {14OS, 128}, resulting in a sensing block duration=8 or 16 msec, {T_{SRI}, k}={7OS, 64} or {7OS, 128}, resulting in a sensing block duration=4 or 8 msec, and for carrier frequencies>50 GHz, k=256, resulting in a sensing block duration=16 or 32 msec for T_{SRI}=70S or 14OS, respectively, and for SCS=120 KHz, a sensing OFDM symbol duration including a cyclic prefix (CP) duration is configurable between {8.92, 8.92+X} us, and for SCS=480 KHz, the sensing OFDM symbol duration is configurable between {2.23, 2.23+X} us, where X is dependent on a range detection requirement.

In Example 6, the subject matter of Examples 1-5 includes the maximum detectable velocity to meet an SRI Nyquist rate, keep ICI within a predetermined tolerable limit, and limit range migration is:

$${v}_{max} \leq Min ( \frac{{c}_{0}}{4 {f}_{c} {T}_{SRI}} , \frac{{c}_{0} \times SCS}{2 \times m \times {f}_{c}} , \frac{Δ d}{k \times {T}_{SRI}} ) ,$$

where Δd is a range resolution that is a minimum distance to distinguish between two targets with identical velocity.

In Example 7, the subject matter of Examples 1-6 includes, wherein the processing circuitry configures the sensing device to map and transmit the modulated symbols based on a fifth generation (5G) NR Downlink (DL) Positioning Reference Signal (PRS) design in which: a sensing block duration is a duration of a PRS resource set and is dependent on repetition parameters and a number of resources within the PRS resource set, a number of PRS resources within the PRS resource set is a number of beam directions covered within the SRI and a number of OFDM symbol pairs within the SRI, the SRI is a collection of one occurrence of all PRS resources within the PRS resource set, a pattern of resources and directions across SRIs within a sensing block is identical and a configuration of PRS resources in different PRS resource sets is consistent, a repetition factor for PRS resource repetition within one instance of resource set is k, and a periodicity of the PRS resource set is an update rate for sensing.

In Example 8, the subject matter of Example 7 includes, wherein the processing circuitry configures the sensing device to support: a maximum number of PRS repetitions includes {1, 2, 4, 6, 8, 16, 32, 64, 128} or {1, 2, 4, 6, 8, 16, 32, 64, 128, 256}, use of consecutive subcarriers by PRS with or without repetitions within a PRS resource, use of partially staggered patterns for PRS signals defined by an M-level comb and N symbols for a PRS resource with M>N, unstaggered patterns for the PRS signals over multiple OFDM symbols such that identical consecutive or comb-structured resource elements (REs) are used in consecutive symbols within a particular PRS resource, combinations of fully or partially staggered and unstaggered patterns for the PRS signals, and use of all symbols within a slot for PRS allocation.

In Example 9, the subject matter of Example 7 includes, wherein a PRS configuration allows: non-consecutive OFDM symbols for transmission of non-PRS symbols within a PRS slot, a PRS resource occupying a single OFDM symbol, non-consecutive allocation of OFDM symbols per PRS resource within a slot, non-consecutive allocation of OFDM symbols per PRS resource within a slot such that the non-consecutive OFDM symbols are symmetric with respect to a half-slot boundary, configurations of a repetition pattern, which includes a repetition factor and repetition gap, at a granularity of each PRS resource, the repetition gap to be configured in a number of OFDM symbols, more than two PRS resource sets per PRS frequency layer, and multiple PRS resource sets with common settings of plurality of configuration parameters for resources within the PRS resource sets.

Example 10 is an apparatus of a sensing device in a next generation (NG) network, the apparatus comprising: processing circuitry to configure the sensing device to: generate a pseudo random sequence; modulate the pseudo random sequence into modulation symbols; map at least some of the modulation symbols to allocated resource elements (REs) of an Orthogonal Frequency Division Multiplexing (OFDM) resource grid; transmit the modulated symbols in time and frequency resources of the REs; and measure reflections of the modulated symbols from an environment of the sensing device in at least one of a time, frequency, spatial, or angular domain; and memory configured to store the modulated symbols.

In Example 11, the subject matter of Example 10 includes, wherein the processing circuitry configures the sensing device to use a Positioning Reference Signal (PRS) for sensing having a PRS resource or PRS resource set configuration that at least partially uses a different sequence generation and initialization compared to that of a PRS for positioning.

In Example 12, the subject matter of Example 11 includes, wherein the processing circuitry configures the sensing device to at least one of: use at least one of parameters slot number, OFDM symbol index, and downlink (DL) PRS sequence identification (ID) in the initialization (“c”_init), or generate and initialize sequences based on symbol number for sensing.

In Example 13, the subject matter of Examples 10-12 includes wherein at least one of: a pseudo-random sequence for a sensing signal is initialized based on one or more of: at least one of symbol index, slot number, subframe number, radio frame number, or Symbol Repetition Interval (SRI) index number within a sensing frame in which the sensing signal is being transmitted, physical layer cell identity (ID), cyclic prefix (CP) duration, number of SRI in a sensing frame, or number of OFDM symbols within an SRI, or for UE-based sensing, in which a UE transmits the sensing signal, at least one of: a device-specific parameter is included in initialization of a sequence used in signal generation and transmission by the UE, or pseudo-orthogonality between generated sequences is used to at least reduce interference between sensing signals from multiple devices in the network.

In Example 14, the subject matter of Examples 10-13 includes wherein at least one of: a sensing ID is assigned to each device in a network that generates sensing signals, for bi-static sensing, in which the sensing signal is based on a Positioning Reference Signal (PRS), all devices involved in sensing are provided initial settings, sequence parametrization, and initializations, at least one of sensing time, frequency, or spatial resources at least overlap for transmission of sensing signals across the network, and pseudo-orthogonality between generated sequences separates the overlapped sensing signals, initial values in different cells vary dependent on changes in at least one of subframe number, slot number, or OFDM symbol number between cells, and the pattern of variation is cell-specific, or the OFDM symbol number is in a radio frame unit so that changes of initialization are different as the OFDM symbol number varies.

In Example 15, the subject matter of Examples 10-14 includes wherein a sequence in a sensing signal is selected at different offsets from basic generated sequences to introduce randomization in the sensing signal, and reduce overlapping of generated pseudo-random sequences, and the offsets are functions of at least one of: at least one of symbol index, slot number, subframe number, radio frame number, or Symbol Repetition Interval (SRI) index number within a sensing frame in which the sensing signal is being transmitted, physical layer cell identity (ID), cyclic prefix (CP) duration, number of SRIs in a sensing frame, or number of OFDM symbols within an SRI.

Example 16 is a computer-readable storage medium that stores instructions for execution by one or more processors of a sensing device, the one or more processors to configure the sensing device to, when the instructions are executed: determine a signal sequence based on a pseudo-random sequence; modulate the signal sequence into a modulation symbol; map at least a portion of the signal sequence to allocated time and frequency and spatial resources; transmit, on the allocated resources, a sensing signal message that includes the signal sequence; and measure reflections of the modulated symbols from an environment of the sensing device in at least one of a time, frequency, spatial, or angular domain.

In Example 17, the subject matter of Example 16 includes wherein at least one of the signal sequence is modulated into the modulation symbol via quadrature phase shift keying (QPSK) modulation, or the allocated RE is associated with an orthogonal frequency division multiplexing (OFDM) resource grid.

In Example 18, the subject matter of Examples 16-17 includes wherein at least one of: the sensing signal message is based on a positioning reference signal (PRS), or the sensing signal message is based on a plurality of PRS signals transmitted across different cells using different frequency, time, or spatial domain resources.

In Example 19, the subject matter of Examples 16-18 includes wherein sensing signal generation or initialization is based on one or more of: a symbol index, a slot number, a subframe number, a radio frame number, a Symbol Repetition Interval (SRI) number, a physical layer cell identity, a cyclic prefix (CP) duration, a number of SRIs in a sensing frame, and a number of orthogonal frequency division multiplexing (OFDM) symbols within an SRI.

In Example 20, the subject matter of Examples 16-19 includes wherein a device-specific parameter is included in an initialization of the signal sequence and includes a sensing identifier.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Example 25 is an apparatus to implement of any of Examples 1-20, wherein the sensing device is a 5^{th} generation NodeB (gNB).

Example 26 is an apparatus to implement of any of Examples 1-20, wherein the sensing device is a user equipment (UE).

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus of a sensing device in a next generation (NG) network, the apparatus comprising:
processing circuitry to configure the sensing device to:
generate a signal sequence based on a length-31 Gold sequence;
modulate the signal sequence into modulation symbols;
map at least some of the modulation symbols to allocated resource elements (REs) of an Orthogonal Frequency Division Multiplexing (OFDM) resource grid;
transmit the modulation symbols in time and frequency resources of the REs; and
measure reflections of the modulation symbols from an environment of the sensing device in at least one of a time, frequency, spatial, or angular domain; and
memory configured to store the modulation symbols.

22. The apparatus of claim 21, wherein the processing circuitry configures the sensing device to use a Positioning Reference Signal (PRS) for sensing having a PRS resource or PRS resource set configuration that at least partially uses a different sequence generation and initialization compared to that of a PRS for positioning.

23. The apparatus of claim 22, wherein the processing circuitry configures the sensing device to at least one of:
use parameters other than slot number, OFDM symbol index, and downlink (DL) PRS sequence identification (ID) in the initialization (“c”_init),
remove at least one of the slot number, OFDM symbol index, and DL PRS sequence ID from the initialization, or
generate and initialize sequences based on symbol number for sensing.

24. The apparatus of claim 21, wherein at least one of:
a pseudo-random sequence for a sensing signal is initialized based on one or more of:
at least one of symbol index, slot number, subframe number, radio frame number, or Symbol Repetition Interval (SRI) number in which the sensing signal is being transmitted,
physical layer cell identity (ID),
cyclic prefix (CP) duration,
number of SRI in a sensing frame, or
number of OFDM symbols within an SRI, or for UE-based sensing, in which a UE transmits the sensing signal, at least one of:
a device-specific parameter is included in initialization of a sequence used in signal transmission by the UE, or
pseudo-orthogonality between generated sequences is used to at least reduce interference between sensing signals from multiple devices in the NG network.

25. The apparatus of claim 21, wherein at least one of:
a sensing ID is assigned to each device in a network that generates sensing signals,
for bi-static sensing, in which a sensing signal is based on a Positioning Reference Signal (PRS), all devices involved in sensing are provided initial settings, sequence parametrization, and initializations,
at least one of sensing time, frequency, or spatial resources at least overlap for the sensing signals across the network, and pseudo-orthogonality between generated sequences separates the overlapped sensing signals,
initial values vary dependent on changes in at least one of subframe number, slot number, or OFDM symbol number between cells, or
the OFDM symbol number is in a radio frame unit so that changes of initialization are different as the OFDM symbol number varies.

26. The apparatus of claim 21, wherein:
the signal sequence in a sensing signal is selected at different offsets from basic sequences generated to introduce randomization in the sensing signal, and avoid overlapping of generated pseudo-random sequences, and
the offsets are functions of at least one of:
at least one of symbol index, slot number, subframe number, radio frame number, or Symbol Repetition Interval (SRI) number in which the sensing signal is being transmitted,
physical layer cell identity (ID),
cyclic prefix (CP) duration,
number of SRI in a sensing frame, or
number of OFDM symbols within an SRI.

27. An apparatus of a sensing device in a next generation (NG) network, the apparatus comprising:
processing circuitry to configure the sensing device to:
map modulated symbols to time and frequency resources of an Orthogonal Frequency Division Multiplexing (OFDM) resource grid such that a total time span (T_{SRI}, where SRI is a Symbol Repetition Interval) over which recurring OFDM symbols are occupied by the modulated symbols is a multiple integer (k) of a periodicity with which the modulated symbols are mapped to OFDM symbols, limits of T_{SRI} are dependent on a subcarrier spacing (SCS) of the OFDM resource grid, inter-carrier interference (ICI), a carrier frequency (f_{c}), a maximum detectable velocity (vₘₐₓ), and a speed of light (c₀), and limits of k are dependent on bandwidth (BW), T_{SRI}, resolution with which a velocity is detected (Δᵥ), the carrier frequency, and the speed of light; and
transmit the modulated symbols, mapped to the OFDM resource grid, using a single spatial precoding; and
memory configured to store the modulated symbols.

28. The apparatus of claim 27, wherein:
T_{SRI} satisfies:
$$\frac{m}{2 \times SCS} \leq {T}_{SRI} and {T}_{SRI} \leq \frac{{c}_{0}}{4 {f}_{c} {v}_{max}} ,$$
and
k satisfies:
$$\frac{{c}_{0}}{2 {f}_{c} Δ v \times {T}_{SRI}} \leq k \leq \frac{2 {f}_{c}}{BW} .$$

29. The apparatus of claim 28, wherein the processing circuitry configures the sensing device to map the modulated symbols to the OFDM resource grid such that dimensioning of a cyclic prefix duration (T_{cp}) in the OFDM symbols for the SCS is not to achieve ISI-free detection for a maximum desired distance, a non-ideal performance is tolerated up to a distance n×c₀T_{cp}/2, where n is selected such that objects at distance d are detectable without aliasing, and d meets:
$${d}_{max , no - ISI} \leq \frac{{c}_{0} {T}_{cp}}{2} \leq d \leq n \times \frac{{c}_{0} {T}_{cp}}{2} \leq {d}_{max , unambig} = \frac{{c}_{0}}{( 2 \times SCS )} .$$

30. The apparatus of claim 29, wherein the processing circuitry configures the sensing device to:
select n dependent on a sensing environment; and
map the modulated symbols to the OFDM resource grid such that the SCS used for mapping of the modulated symbols within a total frequency span over which recurring subcarriers are occupied by the modulated symbols is based on a largest integer value m_{comb} for which n×c₀T_{cp}/2≤c₀/m_{comb}(2×SCS) is derived, and the modulated symbols are mapped to every m_{comb}-th subcarrier.

31. The apparatus of claim 27, wherein:
T_{SRI} is 7, 14, or 28 OFDM symbols (OS), dependent on the maximum detectable velocity, for carrier frequencies in Frequency Range 1 (FR1), supported SRI durations include:
$$for SCS = 15 KHz , \{ {T}_{SRI} , k \} = \{ 7 OS , 32 \} , or \{ 7 OS , 64 \} ,$$
$$for SCS = 30 KHz , \{ {T}_{SRI} , k \} = \{ 14 OS , 32 \} , \{ 14 OS , 64 \} , \{ 7 OS , 64 \} , or \{ 7 OS , 128 \} ; and$$
$$for SCS = 60 KHz , \{ {T}_{SRI} , k \} = \{ 28 OS , 32 \} , \{ 28 OS , 64 \} , \{ 14 OS , 64 \} , of \{ 14 OS , 128 \} ,$$
which result in a sensing block duration=k×T_{SRI}=16 or 32 msec, and for carrier frequencies in FR2, supported SRI durations include:
for SCS=60 KHz, {T_{SRI},k}={7OS, 64} or {7OS, 128}, which result in a sensing block duration=8 or 16 msec, for carrier frequencies<30 GHz, {T_{SRI},k}={14OS, 32}, {14OS, 64}, or {14OS, 128}, resulting in a sensing block duration=8, 16, or 32 msec, and for carrier frequencies>50 GHz, {T_{SRI}, k}={7, 256}, resulting in a sensing block duration=32 msec,
for SCS=120 KHz, {T_{SRI}, k}={14OS, 64} or {14OS, 128}, resulting in a sensing block duration=8 or 16 msec, {T_{SRI}, k}={7OS, 64} or {7OS, 128}, resulting in a sensing block duration=4 or 8 msec, and for carrier frequencies>50 GHz, k=256, resulting in a sensing block duration=16 or 32 or msec for T_{SRI}=70S or 14OS, respectively, and
for SCS=120 KHz, a sensing OFDM symbol duration including a cyclic prefix (CP) duration is configurable between {8.92, 8.92+X} us, and for SCS=480 KHz, the sensing OFDM symbol duration is configurable between {2.23, 2.23+X} us, where X is dependent on a predetermined range.

32. The apparatus of claim 27, wherein the maximum detectable velocity to meet an SRI Nyquist rate, keep ICI within a predetermined tolerable limit, and limit range migration is: vₘₐₓ≤Min
$$( \frac{{c}_{0}}{4 {f}_{c} {T}_{SRI}} , \frac{{c}_{0} \times SCS}{2 \times m \times {f}_{c}} , \frac{Δ d}{k \times {T}_{SRI}} ) ,$$
where Δ_{d} is a range resolution that is a minimum distance to distinguish between two targets with identical velocity.

33. The apparatus of claim 27, wherein the processing circuitry configures the sensing device to map and transmit the modulated symbols based on a fifth generation (5G) NR Downlink (DL) Positioning Reference Signal (PRS) design in which:
a sensing block duration is a duration of a PRS resource set and is dependent on repetition parameters and a number of resources within the PRS resource set, a number of PRS resources within the PRS resource set is a number of beam directions covered within the SRI and a number of OFDM symbol pairs within the SRI,
the SRI is a collection of one occurrence of all PRS resources within the PRS resource set, a pattern of resources and directions across SRIs within a sensing block is identical and a configuration of PRS resources in different PRS resource sets is consistent,
a repetition factor for PRS resource repetition within one instance of resource set is k, and
a periodicity of the PRS resource set is an update rate for sensing.

34. The apparatus of claim 33, wherein the processing circuitry configures the sensing device to support:
a maximum number of PRS repetitions includes {1, 2, 4, 6, 8, 16, 32, 64, 128} or {1, 2, 4, 6, 8, 16, 32, 64, 128, 256},
use of consecutive subcarriers over one OFDM symbol by PRS signals with or without repetitions within a PRS resource,
use of partially staggered patterns for PRS signals defined by an M-level comb and N symbols for a PRS resource with M>N,
unstaggered patterns for the PRS signals such that identical resource elements (REs) are used in consecutive symbols within a particular PRS resource,
combinations of fully or partially staggered and unstaggered patterns for the PRS signals, and
use of all symbols within each slot for PRS allocation.

35. The apparatus of claim 33, wherein a PRS configuration allows:
non-consecutive OFDM symbols for a non-PRS transmission within a PRS slot, a single-symbol PRS resource,
non-consecutive allocation of OFDM symbols per PRS resource within a slot, configurations of a repetition pattern, which includes a repetition factor and repetition gap, at a granularity of each PRS resource,
the repetition gap to be configured in a number of OFDM symbols,
more than two PRS resource sets per PRS frequency layer, and
multiple PRS resource sets with common resource settings within the PRS resource sets.

36. A non-transitory computer-readable storage medium that stores instructions for execution by one or more processors of a sensing device, the one or more processors to configure the sensing device to, when the instructions are executed:
determine a signal sequence based on a Gold sequence;
modulate the signal sequence into a modulation symbol;
map at least a portion of the signal sequence to an allocated resource element (RE);
transmit, on the allocated RE, a sensing signal message that includes the signal sequence; and
measure reflections of the modulation symbol from an environment of the sensing device in at least one of a time, frequency, spatial, or angular domain.

37. The non-transitory computer-readable storage medium of claim 36, wherein at least one of:
the signal sequence is modulated into the modulation symbol via quadrature phase shift keying (QPSK) modulation, or
the allocated RE is associated with an orthogonal frequency division multiplexing (OFDM) resource grid.

38. The non-transitory computer-readable storage medium of claim 36, wherein at least one of:
the sensing signal message is based on a positioning reference signal (PRS), or
the sensing signal message is based on a plurality of different PRS signals transmitted across different cells using different frequency domain resources.

39. The non-transitory computer-readable storage medium of claim 36, wherein the sensing signal message is based on a PRS resource that includes one or more of: a symbol index, a slot number, a subframe number, a radio frame number, a Symbol Repetition Interval (SRI) number, a physical layer cell identity, a cyclic prefix (CP) duration, a number of SRIs in a sensing frame, and a number of orthogonal frequency division multiplexing (OFDM) symbols within an SRI.

40. The non-transitory computer-readable storage medium of claim 36, wherein a device-specific parameter is included in an initialization of the signal sequence and includes a sensing identifier.
